(19) United States
(12) Patent Application Publication
(10) Pub. No.: US 2014/0317137 A1
(43) Pub. Date: Oct. 23, 2014

(54) LOG MANAGEMENT COMPUTER AND LOG MANAGEMENT METHOD

(71) Applicants: Miyuki Hanaoka, Tokyo (JP); Shinichi Kawamoto, Tokyo (JP); Tadataka Matsubayashi, Tokyo (JP)

(72) Inventors: Miyuki Hanaoka, Tokyo (JP); Shinichi Kawamoto, Tokyo (JP); Tadataka Matsubayashi, Tokyo (JP)

(73) Assignee: HITACHI, LTD., Tokyo (JP)

(21) Appl. No.: 14/355,139

(22) PCT Filed: Mar. 12, 2012
(86) PCT No.: PCT/JP2012/056303

§ 371 Date: Apr. 29, 2014

(51) Int. Cl. G06F 17/30

(52) U.S. Cl. CPC G06F 17/30106
USPC 707/758

(57) ABSTRACT

The purpose of the invention is to provide a log management computer that shortens log search time while reducing log storage volume. The log management computer manages a log acquired from a log generating system that generates the log, which is an operation record. The log management computer is characterized by: extracting from a log message contained in the log, both a common portion that is common with another log message and a different portion that is different from another log message; storing the extracted common portion in common portion information of a storage area; storing the extracted different portion in different portion information of the storage area; and if a search request containing a search condition is received, searching for a log message that matches the search condition.

### BACKGROUND OF THE INVENTION

This invention relates to a log management computer for obtaining and managing a log that is obtained from a log generating system for generating a log which is an operation record. In particular, this invention relates to a log management computer for storing obtained logs and searching the obtained logs for a given search criteria.

A log is a record of the operation of a device or the like. One line constituting a part of a log is usually one operation record of a log generating system. A log management system collects a log generated by the log generating system, and accumulates the collected logs in a storage area. In response to a search request from a user, the log management system searches the accumulated logs for a log that matches the search request, and returns the result of the search.

Examples of the log generating system include various manufacturing apparatus, various types of embedded equipment, and information technology (IT) equipment such as server machines, storage, and network machines.

Logs generated by log generating systems are classified into structured logs and unstructured logs. Structured logs are generated mostly by various manufacturing apparatus, embedded equipment, and the like. Structured logs have a structured output format as illustrated in FIG. 26.

Unstructured logs are generated mostly by IT equipment that executes an OS, middleware, an application, and the like. Unstructured logs are unstructured in that the output format varies from one line to another as illustrated in FIG. 27.

A log generating system transmits a log in a text format to a log management system. Alternatively, the log generating system may convert a text-format log into a binary format by encoding the text-format log by a given method, and transmit the log converted into a binary format to the log management system.

The log management system receives the log transmitted from the log generating system and stores the received log in a file system or the like in the format in which the log has been transmitted, or stores the log in a database such as a relational database.

A structured log database which is a database for storing structured logs is illustrated in FIG. 28. The structured log database for storing structured logs which have a structured output format can be any relational database whose schema is designed to the output format of structured logs.

An unstructured log database which is a database for storing unstructured logs is illustrated in FIG. 29.

Portions common to lines of an unstructured log (datetime 302, a level 303, and a host name 304 which are illustrated in FIG. 27) are stored in corresponding columns. For instance, the datetime 302 of an unstructured log is registered in a column for a datetime 502 of FIG. 29, the level 303 of the unstructured log is registered in a column for a level 503 of FIG. 29, and the host name 304 of the unstructured log is registered in a column for a host 504 of FIG. 29.

A message 305 of the unstructured log varies from one line to another. Consequently, word structures constituting the respective messages 305 cannot be registered in a common column which has a fixed structure. The message 305 of the unstructured log is therefore generally stored as an msg 505 as it is.

A stored log takes up a capacity that increases in proportion to the recording time because a log is a record of the operation of a device or the like as described above. The capacity taken up by stored logs also increases in proportion to the count of log generating systems to be managed.

A known solution to the problem of an increase in capacity taken up by stored logs is a method in which a mass of logs is compressed in order to store compressed logs and thus reduce the capacity taken up by stored logs, and a log search is conducted after the compressed logs are decompressed (see, for example, Japanese Patent Application Laid-open No. 2004-185460).

The operation type of a device that outputs a log is limited, and the types of operation records indicated by logs are accordingly limited. This means that long-term logs include a plurality of logs that are the same type of operation records. In a known method, pieces of data included in a structured log that appear at a given proportion or more and that indicate the same specifics are integrated to be stored in a consolidation table, whereas other pieces of data are stored in a table for storing a normal log(see, for example, Japanese Patent Application Laid-open No. 2009-169474). The capacity taken up by stored logs is thus reduced.

Another issue to be addressed is to shorten the search time for searching logs. Generally speaking, a search of logs stored as text files involves searching all contents of all logs to extract logs that contain a keyword which is a search criterion. For instance, the grep command of UNIX (registered trademark) employs the search method described above. There is also known a method of avoiding a search of all entries in the case of managing structured logs in a relational database by attaching an index to columns of the relational database.

However, an index cannot be attached to the msg 505 in a relational database for unstructured logs, which leaves a problem in that an all-entry search needs to be conducted to search portions registered as the msg 505.

A known method that deals with this involves extracting a word that is registered as the msg 505 and attaching the extracted word to the msg 505 as an index, to thereby avoid searching all entries and cut short the search time (see, for example, Roger Ford, “Oracle Text An Oracle Technical White Paper”, June, 2007, pp. 5-9 (hereinafter referred to as “Non Patent Literature 1”)). Another known method shortens the search time by attaching an index to the time stamp of a log such as the datetime 502 (see, for example, Ledion Bitincka, Archana Ganapathi, Stephen Sorkin, and Steve Zhang, “Optimizing Data Analysis with a Semi-structured Time Series Database”, USENIX Association, 2010, pp. 4-5 (hereinafter referred to as “Non Patent Literature 2”)).

### SUMMARY OF THE INVENTION

The method of Japanese Patent Application Laid-open No. 2004-185460 is capable of reducing the capacity taken up by stored logs. The method of Japanese Patent Application Laid-open No. 2004-185460, however, requires time to compress a log when the log is to be stored and time to decompress logs when the logs are to be searched, and accordingly takes long to store a log and to search logs.

The method of Japanese Patent Application Laid-open No. 2009-169474 is capable of reducing the capacity taken up by stored unstructured logs. For instance, in the relational database for an unstructured log of FIG. 29, the same specifics as those of other lines are registered as the level 503 and the host 504 at a given proportion or more, and can therefore be integrated to be registered in a consolidation table as illustrated in FIG. 30A and FIG. 30B. FIG. 30A is a data table in which a datetime and msg of an unstructured log are stored. FIG. 30B is a consolidation table in which a level and host of an unstructured log are stored. The capacity taken up by stored logs is thus reduced by the amount of consolidated values of the level and host of unstructured logs. However, the msg which takes up most of an unstructured log is shared by few logs and cannot be consolidated. The capacity taken up by stored logs is therefore hardly reduced.

Turning to the issue of the search time of unstructured logs, the methods of Non Patent Literature 1 and Non Patent Literature 2 in which index search is made executable are capable of shortening the search time. The methods of Non Patent Literature 1 and Non Patent Literature 2, however, cannot solve the issue of reducing the capacity that is taken up by stored logs.

An object of this invention is to provide a log management computer, which cuts short the log search time, while reducing the capacity that is taken up by stored logs.

An exemplary embodiment of the invention disclosed herein is as follows: a log management computer for managing a log that is obtained from a log generating system for generating a log which is an operation record, comprising: a storage area for storing the obtained log; and a processor which refers to the log stored in the storage area, wherein the processor is configured to: extract, from a log message which is included in the log obtained from the log generating system, a common portion which is common to the log message and other log messages and a different portion which differs from other log messages; store the extracted common portion in common portion information of the storage area; store the extracted different portion in different portion information of the storage area; and refer, when receiving a search request which includes a search criterion, to at least one of the common portion information and the different portion information to search for a log message that meets the search criterion.

According to one embodiment of this invention, the search processing time is cut short while the capacity taken up by stored logs is reduced.

### BRIEF DESCRIPTION OF THE DRAWINGS

FIG. 1 is a configuration diagram of an information processing system according to a first embodiment of this invention.

FIG. 2 is a block diagram of a log management computer and one storage device according to the first embodiment of this invention.

FIG. 3 is an explanatory diagram of a log table according to the first embodiment of this invention.

FIG. 4 is an explanatory diagram of a common table according to the first embodiment of this invention.

FIG. 5 is an explanatory diagram of a term table according to the first embodiment of this invention.

FIG. 6 is an explanatory diagram of a variable table according to the first embodiment of this invention.

FIG. 7 is an explanatory diagram of a variable definition table according to the first embodiment of this invention.

FIG. 8 is an explanatory diagram of a temporary common table according to the first embodiment of this invention.

FIG. 9 is a flow chart of log storing processing based on the variable definition table according to the first embodiment of this invention.

FIG. 10 is a flow chart of log storing processing based on the common table according to the first embodiment of this invention.

FIG. 11 is a flow chart of search processing according to the first embodiment of this invention.

FIG. 12 is a flow chart of the search processing based on the term table 624 according to the first embodiment of this invention.

FIG. 13 is an explanatory diagram of the search processing based on the term table according to the first embodiment of this invention.

FIG. 14 is a flow chart of the search processing based on the variable table according to the first embodiment of this invention.

FIG. 15 is an explanatory diagram of the search processing based on the variable table according to the first embodiment of this invention.

FIG. 16 is a flow chart of reconfiguration processing by a reconfiguration program according to the first embodiment of this invention.

FIG. 17 is an explanatory diagram of a log displaying screen according to the first embodiment of this invention.

FIG. 18 is an explanatory diagram of a confirmation screen according to the first embodiment of this invention.

FIG. 19 is an explanatory diagram of the log table according to a second embodiment of this invention.

FIG. 20 is an explanatory diagram of the log table according to a third embodiment of this invention.

FIG. 21 is an explanatory diagram of the term table according to the third embodiment of this invention.

FIG. 22 is an explanatory diagram of the variable table according to the third embodiment of this invention.

FIG. 23 is an explanatory diagram of a term-ID table according to a modification example of the third embodiment of this invention.

FIG. 24 is an explanatory diagram of a termid-commonid table according to the modification example of the third embodiment of this invention.

FIG. 25A is an explanatory diagram of a number variable table according to a fourth embodiment of this invention in which the type of a variable portion is a number string.

FIG. 25B is an explanatory diagram of a string variable table according to the fourth embodiment of this invention in which the type of a variable portion is a letter string.

FIG. 25C is an explanatory diagram of an IPaddress variable table according to the fourth embodiment of this invention in which the type of a variable portion is an IP address.

FIG. 26 is an explanatory diagram of a conventional structured log.

FIG. 27 is an explanatory diagram of a conventional unstructured log.

FIG. 28 is an explanatory diagram of a conventional relational database for storing structured logs.

FIG. 29 is an explanatory diagram of a conventional relational database for storing unstructured logs.

FIG. 30A is an explanatory diagram of a conventional data table in which a datetime and msg of the unstructured log are stored.

FIG. 30B is an explanatory diagram of a conventional consolidation table in which a level and host of the unstructured log are stored.

### DETAILED DESCRIPTION OF THE PREFERRED EMBODIMENTS

Modes for carrying out this invention are described below with reference to the drawings. The following description and the drawings include omissions and simplification for a clearer description. Throughout the drawings, the same components are denoted by the same symbols, and a redundant description is omitted if deemed necessary for a clearer description.

### First Embodiment

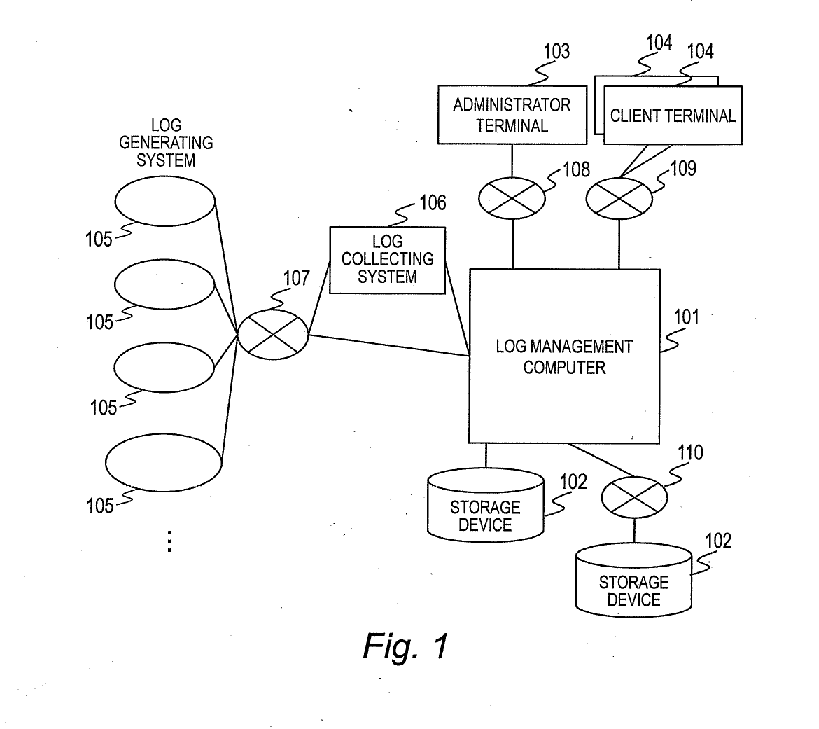

A first embodiment of this invention is described below with reference to FIG. 1 to FIG. 18.

FIG. 1 is a configuration diagram of an information processing system according to the first embodiment of this invention.

The information processing system includes a log management computer 101, log generating systems 105, an administrator terminal 103, client terminals 104, and a log collecting system 106. The log management computer 101 has storage devices 102.

The log generating systems 105 are coupled to the log management computer 101 via a network 107 and the log collecting system 106.

The administrator terminal 103 is coupled to the log management computer 101 via a network 108. The administrator terminal 103 may instead be connected directly to the log management computer 101.

The client terminals 104 are coupled to the log management computer 101 via a network 109. The client terminals 104 may instead be connected directly to the log management computer 101.

The log management computer 101 is coupled to the storage devices 102 via a network 110. The log management computer 101 may instead be connected directly to the storage devices 102.

The networks 107 to 110 can be dedicated lines, wide area networks such as the Internet, and local networks such as a local area network (LAN). At least one pair out of the networks 107 to 110 may be the same network.

The log generating systems 105 are systems that generate an operation record as a log. Each log generating system 105 may generate its own operation record as a log, or may generate an operation record of another apparatus as a log. The log generating systems 105 include at least one of various manufacturing apparatus, various types of embedded equipment, and information technology (IT) equipment such as server machines, storage, and network machines, and may include other apparatus than these.

The log management computer 101 obtains logs generated by the log generating systems 105 and manages the obtained logs. The log management computer 101 may obtain logs covering a given period of time which are obtained by the log collecting system 106. The log collecting system 106 may be installed in the same equipment as the log management computer 101. The log generating systems 105 are not necessarily coupled to the log management computer 101 via the network 107 and the log collecting system 106, and may instead be coupled via the network 107 but not via the log collecting system 106.

Instead of obtaining logs from the log generating systems 105 via the network 107 or via the log collecting system 106, the log management computer 101 may obtain logs from some storage medium (e.g., a portable storage medium) in which logs generated by the log generating systems 105 are stored. The log generating systems 105 in this case do not need to be coupled to the log management computer 101.

The log management computer 101 stores obtained logs in the storage devices 102. The storage devices 102 may be installed in the same equipment as the log management computer 101. The network 110 which couples the log management computer 101 and the storage devices 102 is unnecessary in this case.

The administrator terminal 103 is a computer operated by an administrator of the log management computer 101. The administrator terminal 103 includes a processor and a storage area (which are not shown), and receives an input of various settings and the like of the log management computer 101. When receiving an input, the administrator terminal 103 transmits input information to the log management computer 101. In an environment where an administrator can directly operate the log management computer 101, the information processing system does not need to include the administrator terminal 103.

The client terminals 104 each have a processor and a storage area which are not shown, and transmit a log search request to the log management computer 101. When a search request is received from one of the client terminals 104, the log management computer 101 executes log search processing, and transmits the result of the search to the client terminal 104. The information processing system does not need to include the client terminals 104 in an environment where a search request can be input directly to the log management computer 101.

The administrator terminal 103 and the client terminals 104 may be installed in the same equipment.

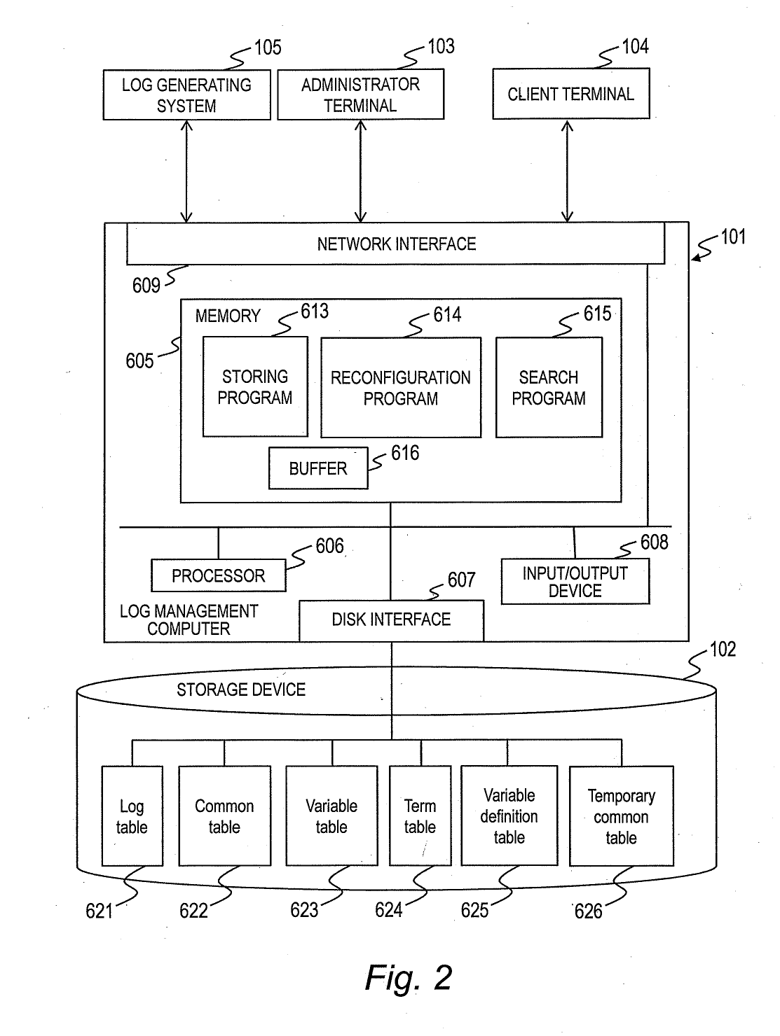

FIG. 2 is a block diagram of the log management computer 101 and one storage device 102 according to the first embodiment of this invention.

The log management computer 101 includes a memory 605, a processor 606, a disk interface 607, an input/output device 608, and a network interface 609. The memory 605, the processor 606, the disk interface 607, the input/output device 608, and the network interface 609 are interconnected by a bus or the like.

The network interface 609 is an interface coupled to the networks 107 to 109, and the log management computer 101 is coupled to each log generating system 105, the administrator terminal 103, and each client terminal 104 via the network interface 609.

The disk interface 607 is an interface coupled to the storage device 102, and the log management computer 101 is coupled to the storage device 102 via the disk interface 607.

The memory 605 is made up of a storage area such as a random access memory (RAM). The input/output device 608 is, for example, a keyboard, a pointer device, and a display, or may be other devices than these. The input/output device may be replaced by a serial interface or an Ethernet interface to which a display-use computer including a display, a keyboard, and a pointer device is connected.

The processor 606 refers to information stored in the memory 605 and executes various types of computing processing.

The log management computer 101, which has one processor 606, one memory 605, and one storage device 102 in FIG. 2, may have a plurality of processors 606, a plurality of memories 605, and a plurality of storage devices 102. The log management computer 101 may also be made up of a plurality of pieces of equipment which have the processors 606, the memories 605, and the storage devices 102, or may share some of the devices, for example, the storage device 102, with other equipment than the log management computer 101.

The memory 605 stores a storing program 613, a reconfiguration program 614, and a search program 615. The memory 605 also has a buffer 616 in which a log can be stored temporarily. The programs 613 to 615 are executed by the processor 606.

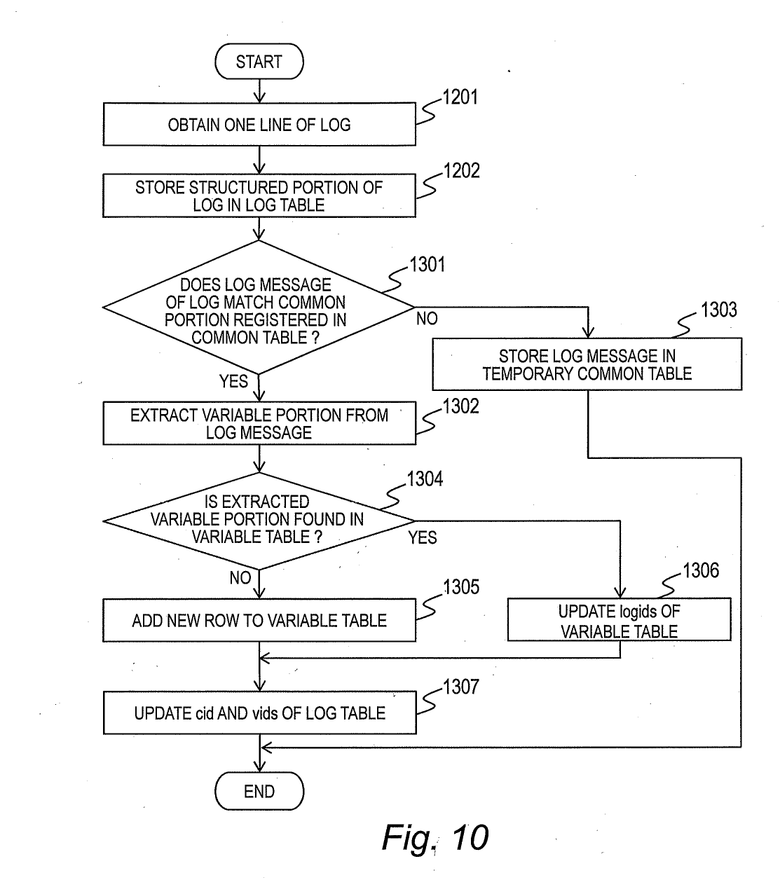

The processor 606 executes the storing program 613, to thereby execute storing processing in which a log obtained by the log management computer 101 is stored in the storage device 102. Details of the storing processing are described with reference to FIG. 9 and FIG. 10.

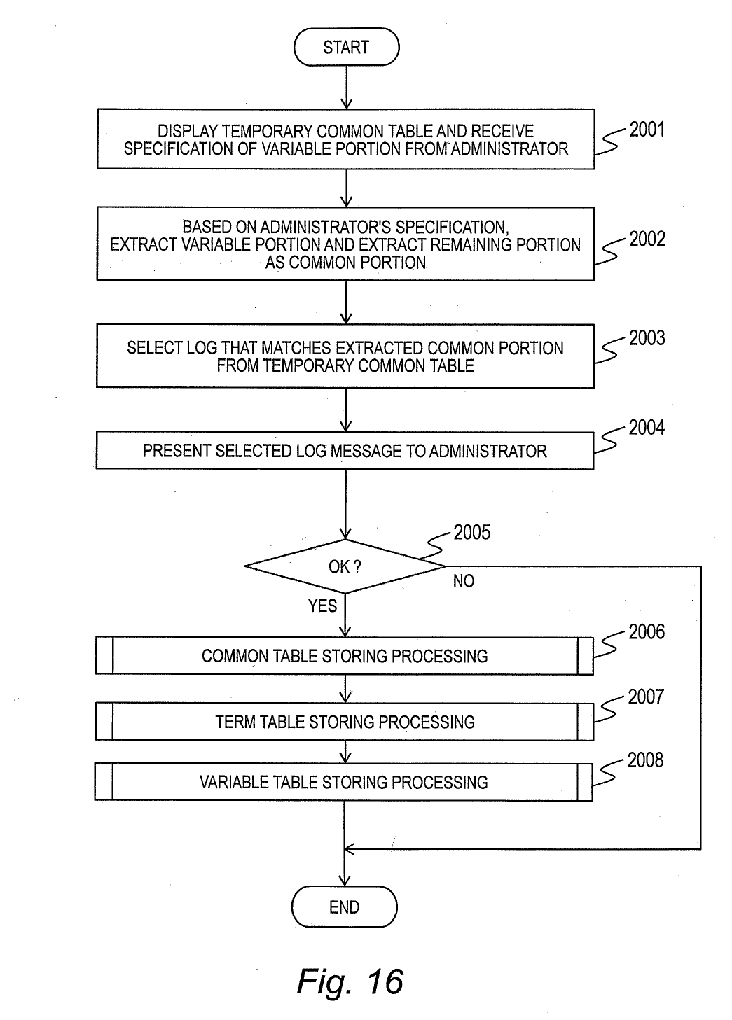

The processor 606 executes the reconfiguration program 614, to thereby execute reconfiguration processing in which accumulated logs are reconfigured. Details of the reconfiguration processing are described with reference to FIG. 16 to FIG. 18.

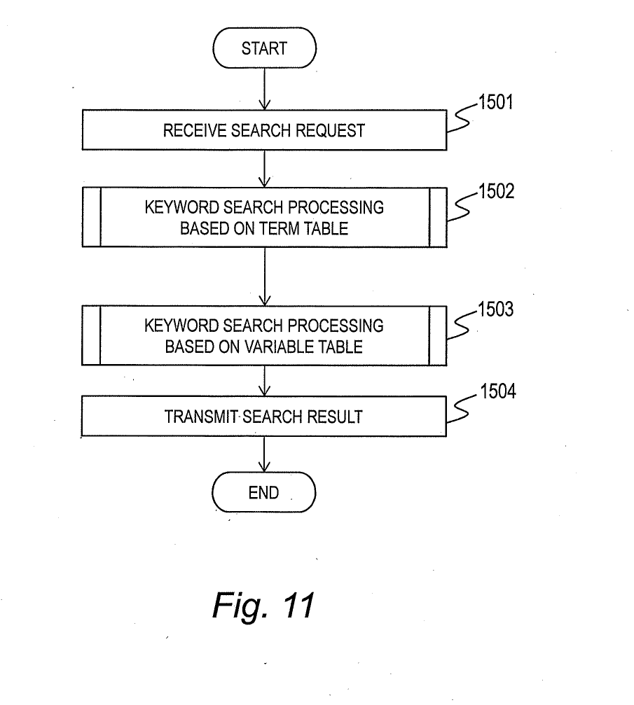

The processor 606 executes the search program 615, to thereby execute search processing in which logs are searched based on a search request transmitted from the client terminal 104. Details of the search processing are described with reference to FIG. 11 to FIG. 15.

A part of or the entirety of the storing processing, reconfiguration processing, and search processing described above may be implemented by hardware by turning the processing into an integrated circuit or the like.

The storage device 102 stores a log table 621, a common table 622, a variable table 623, a term table 624, a variable definition table 625, and a temporary common table 626.

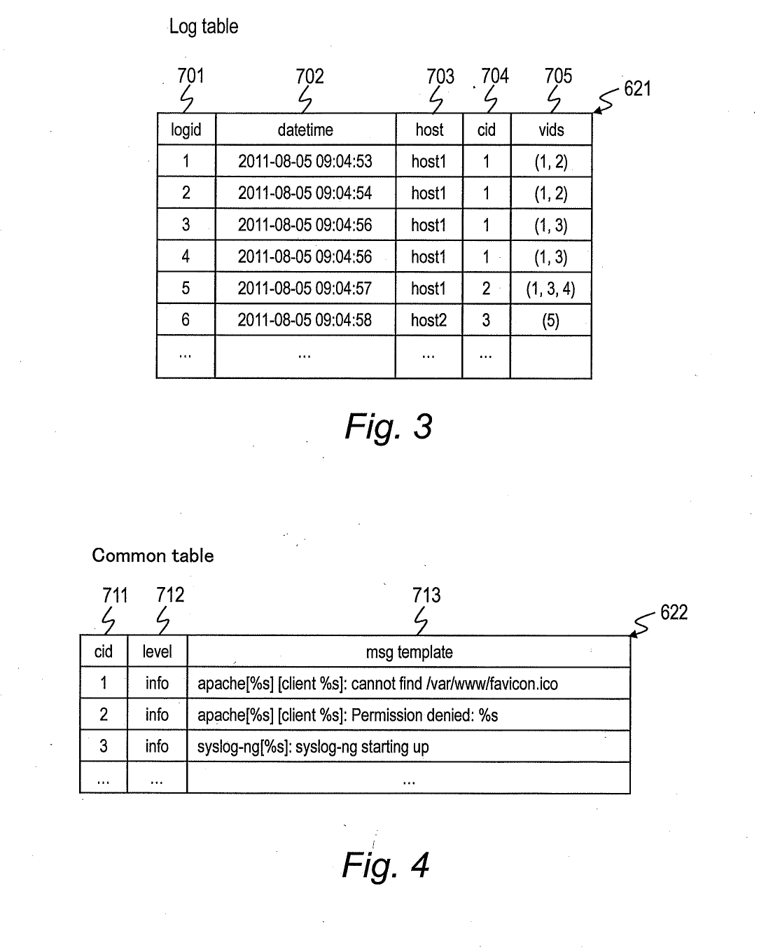

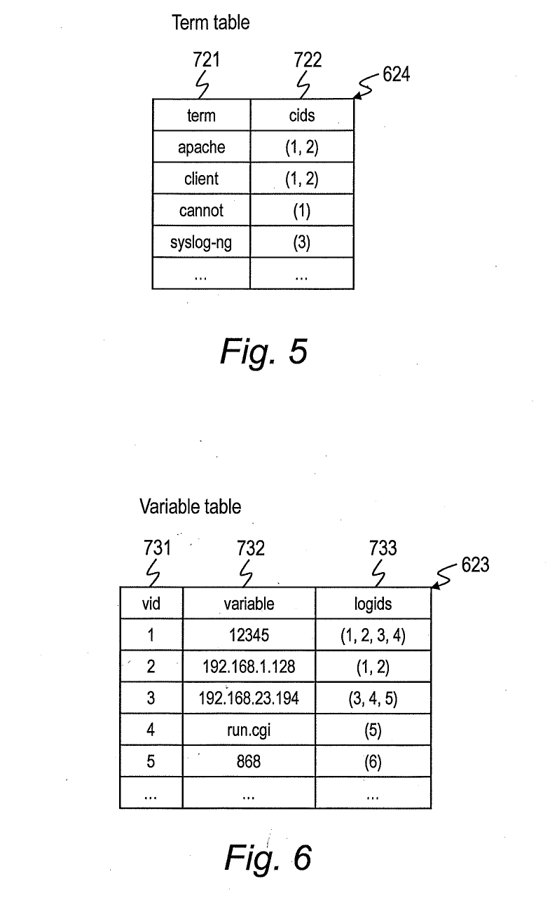

The log table 621 stores a structured portion of a log. Details of the log table 621 are described with reference to FIG. 3. The common table 622 stores a portion common to a log in question and other logs. Details of the common table 622 are described with reference to FIG. 4. The variable table 623 stores a variable portion (different portion) which is a difference from other logs. Details of the variable table 623 are described with reference to FIG. 6. The term table 624 stores a word that constitutes a common portion stored in the common table 622, and index information including information that associates a word with a common portion from which the word is extracted. Details of the term table 624 are described with reference to FIG. 5.

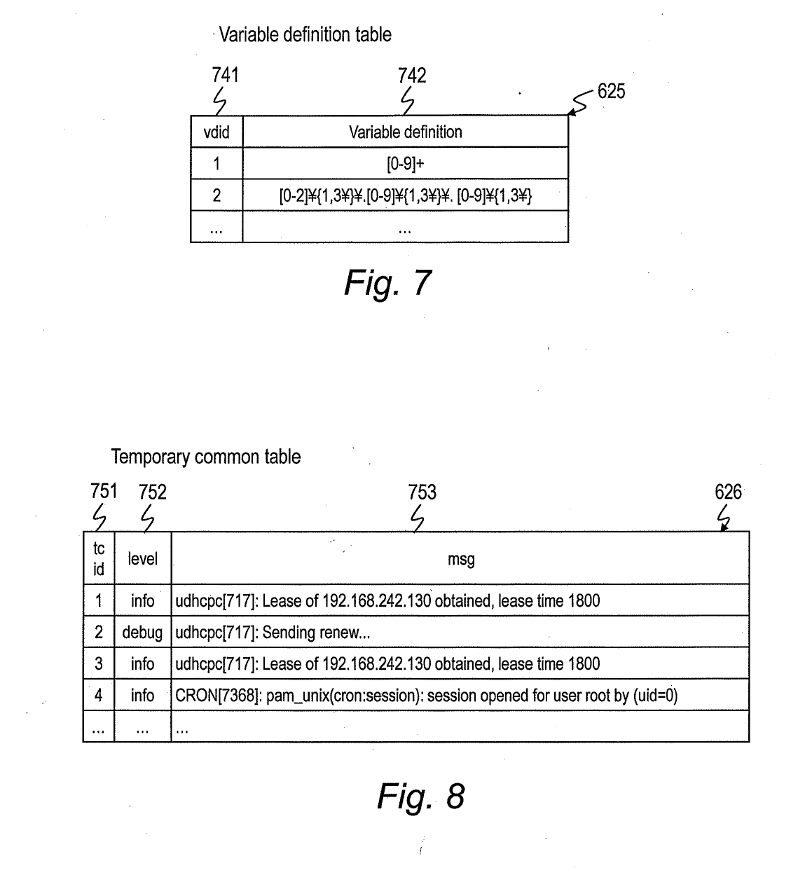

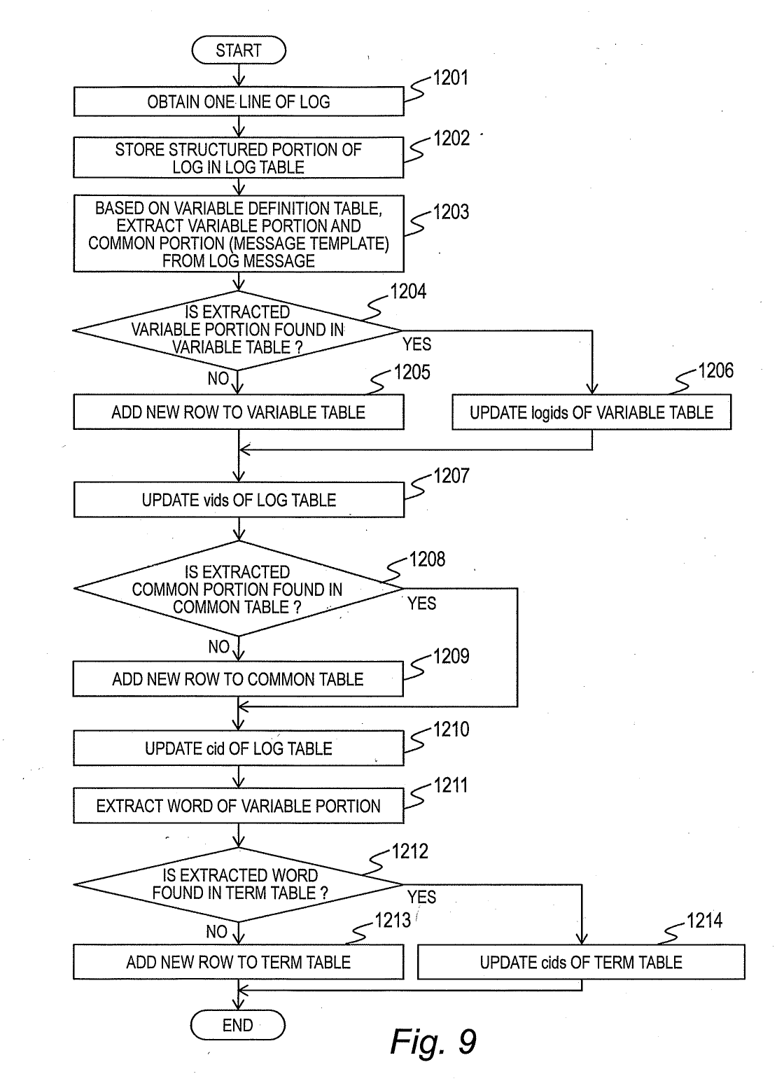

A definition that is set in advance for a variable portion is registered in the variable definition table 625. Details of the variable definition table 625 are described with reference to FIG. 7. The temporary common table 626 stores a log that does not match any common portion stored in the common table 622. Details of the temporary common table 626 are described with reference to FIG. 8.

In this embodiment, the storage medium that stores the tables 621 to 626 is not limited to the storage device 102, and can be any storage medium capable of holding data permanently, such as a semiconductor disk device that uses a flash memory or an optical disc device.

The tables 621 to 626, which are described here as relational database tables as an example, can be any tables in which at least one file stored in a file system and a program for accessing the file are expressed in a table format. For instance, the tables 621 to 626 can be, but are not limited to, tables expressed in a file in a text format or some binary format.

A log that is a processing target of this embodiment is described.

Examples of the processing target log of this embodiment include a syslog which is output from operating systems run on the log generating systems 105, and an unstructured log such as an access log output from the log generating system 105 that is a Web server. The processing target log of this embodiment, however, is not limited to the syslog or the access log.

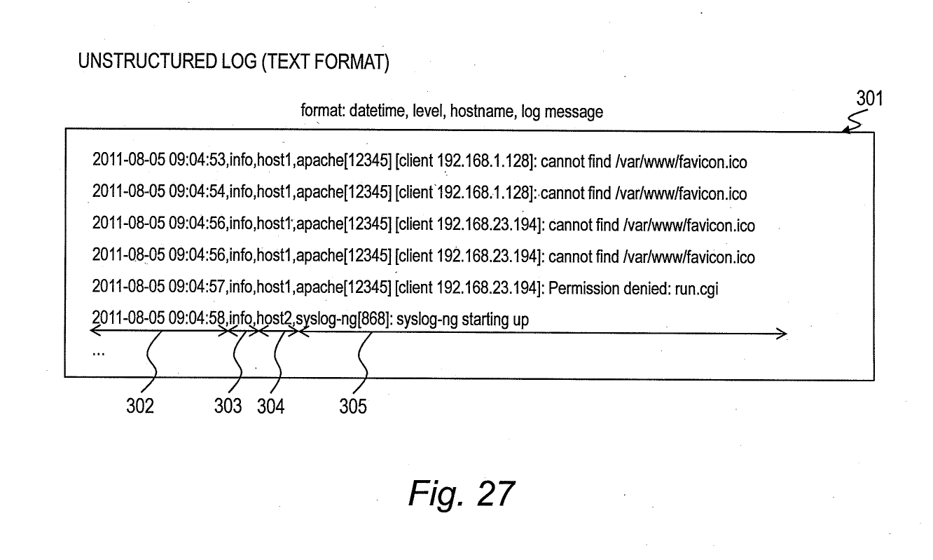

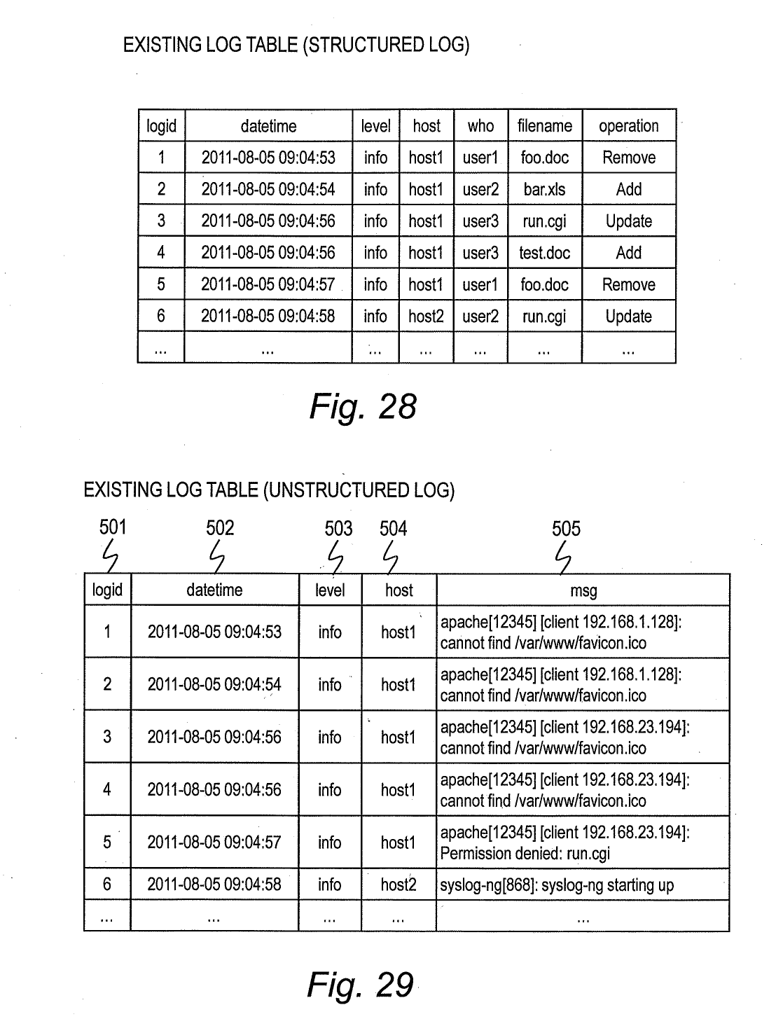

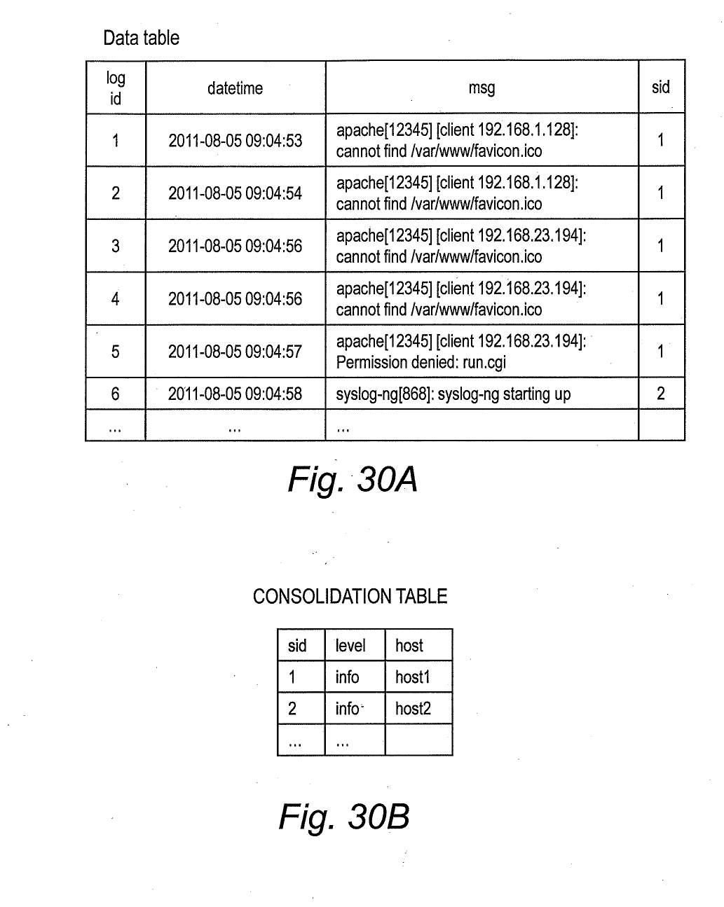

An unstructured log is described with reference to FIG. 27.

One line of a log represents one operation of the log generating system 105 in question in most cases. In other cases, one operation of the log generating system 105 is represented by a plurality of lines of a log.

In FIG. 27, a log 301 includes the date/time (datetime) 302, the level 303, the host name 304, and the log message 305. The date/time 302 indicates a date/time at which the log has been output. The level 303 indicates the degree of importance of the log. The host name 304 indicates identification information of a host included in the log generating system 105 that has executed the operation of the log. The log message 305 indicates the specifics of the operation. In this embodiment, a structured portion of the log 301 includes the date/time 302 and the host name 304, and an unstructured portion of the log 301 includes the level 303 and the log message 305.

The log 301 in FIG. 27 has a CSV format which uses commas and line feeds for segmentation. The first line of the log 301 in FIG. 27 indicates that a host “host1” has generated a log message “apache@[12345] [client 192.168.1.128]: cannot find /var/www/favicon.ico” which has a log level “info” at 09:04:53 on Aug. 5, 2011. What is included in a log is not limited to those in FIG. 27.

A case of storing the log of FIG. 27 as it is in a table is described next with reference to FIG. 29. The table of FIG. 29 includes an ID 501, the date/time (datetime) 502, the level 503, the host name 504, and the log message (msg) 505. The date/time 302 of the log 301 is stored as the date/time 502. The level 303 of the log 301 is stored as the level 503. The host name 304 of the log 301 is stored as the host name 504. The log message 305 of the log 301 is stored as the log message 505. Identification information for identifying the log is stored as the ID 501.

As the log message 505, the log message 305 of the log 301 is stored in free text in one column. Converting a log message that is output in free text as this into a significant structure is difficult, and the log message 305 is therefore stored as it is as one log message 505.

Accordingly, the storing program 613 of this embodiment extracts a common portion and a variable portion from the log message 305 of the log 301, stores the extracted common portion in the common table 622, and stores the extracted variable portion in the variable table 623.

A diversity of messages is stored as the log message 305, which makes it difficult to reduce the capacity by grouping together log messages 305 that match each other in every letter string. In many cases, however, one log message 305 and another log message 305 differ from each other only partially. For instance, the first row and fourth row of the table in FIG. 29 are the same except for the IP address of the client. The storing program 613 in this embodiment extracts, as variable portions, portions different from other log messages 305 such as the IP address, the process identifier (PID), and the file name, and extracts the rest as common portions. Portions extracted as variable portions are not limited to the IP address, the process identifier (PID), and the file name.

A common portion and a variable portion can be extracted from the log message 305 by a plurality of methods, details of which are described through the storing processing of FIG. 9 and FIG. 10.

FIG. 3 is an explanatory diagram of the log table 621 according to the first embodiment of this invention.

The log table 621 stores, for each log, the date/time, host name, and other structured portions of the log.

The log table 621 includes a logid 701, a datetime 702, a host 703, a cid 704, and vids 705.

Identification information of a log is stored as the logid 701. The date/time 302 of the log 301 is registered as the datetime 702. The host name 304 of the log 301 is registered as the host 703.

Registered as the cid 704 is identification information that is registered as a cid 711 in an entry of the common table 622 where a common portion extracted from a log that is identified by the log identification information of the logid 701 is stored.

Registered as the vids 705 is identification information that is registered as a vid 731 in an entry of the variable table 623 where a variable portion extracted from a log that is identified by the log identification information of the logid 701 is stored.

FIG. 4 is an explanatory diagram of the common table 622 according to the first embodiment of this invention.

The common portions extracted from the logs are integrated to be stored in the common table 622. The common table 622 includes the cid 711, a level 712, and an msg template 713.

For each row in the common table 622, identification information of the row is registered as the cid 711. The level 303 of the log 301 which is extracted as a common portion is registered as the level 712. A common portion of the log message 305 of the log 301 which is obtained by extracting the log message 305 minus a variable portion is registered as the msg template 713.

Registered as the msg template 713 in the first row of the common table 622 of FIG. 4 is a common portion (message template) which is obtained by the storing program 613 by removing a variable portion from the log messages of the logs in the first to fourth rows of the table of FIG. 27. A variable portion of a log message is converted into a given letter string (for example, “% s”) so that the log management computer 101 can identify which portion has been a variable portion.

Alternatively, the storing program 613 may store a common portion that is just a log message minus a variable portion as the msg template 713, while separately storing an offset from the head of the removed portion.

In the case where other portions of logs than log messages can be grouped as a common portion, the storing program 613 groups the portions as a common portion and stores in the common table 622. For instance, the log level is registered as the level 712 in FIG. 4. This is because many log levels usually have letter strings that have the same meaning. In the case where other portions than the log level can be grouped as a common portion, the storing program 613 may group the portions as a common portion and store in the common table 622.

FIG. 5 is an explanatory diagram of the term table 624 according to the first embodiment of this invention.

The term table 624 stores an index of a word that constitutes a common portion registered as the msg template 713 in the common table 622. The term table 624 includes a term 721 and cids 722.

A word that constitutes a common portion registered as the msg template 713 in the common table 622 is registered as the term 721. Registered as the cids 722 is identification information that is registered as the cid 711 in a row of the common table 622 that indicates the common portion from which the word registered as the term 721 has been extracted.

The search program 615 can thus identify, when receiving a search request, a common portion in which a word matching a keyword of the search request appears by referring to the term table 624 and obtaining identification information that is registered as the cids 722 from an entry where a word registered as the term 721 matches the keyword.

For example, when “apache” is a keyword included in the search request, the search program 615 refers to the first row of the term table 624, thereby finding out that “apache” appears in the first row (cid: 1) and second row (cid: 2) of the common table 622.

FIG. 6 is an explanatory diagram of the variable table 623 according to the first embodiment of this invention.

The variable table 623 stores a variable portion of a log message. The variable table 623 includes the vid 731, a variable 732, and logids 733.

For each row in the variable table 623, identification information of the row is registered as the vid 731. A variable portion which is extracted from a log message is registered as the variable 732. Registered as the logids 733 is identification information of a row corresponding to a log that contains the log message from which the variable portion has been extracted, out of pieces of identification information registered as the logid 701 in the log table 621.

For example, a PID and an IP address that are extracted as a variable portion of log messages contained in logs in the first to fourth lines of the log of FIG. 27 are stored in the variable table 623. The first row of the variable table 623 indicates that a PID “12345” extracted as a variable portion has been extracted from logs of the first to fourth rows of the log table 621. The second row of the variable table 623 indicates that an IP address “192.168.1.128” extracted as a variable portion has been extracted from logs of the first and second rows of the log table 621.

The cid 704 and vids 705 of the log table 621 associate the cid 711 of the common table 622 with the vid 731 of the variable table 623. In other words, the common table 622 and the variable table 623 include identification information for associating the tables 622 and 623 with each other.

FIG. 7 is an explanatory diagram of the variable definition table 625 according to the first embodiment of this invention.

A variable portion pattern defined by the administrator is registered in the variable definition table 625. The variable definition table 625 includes a vdid 741, and a variable definition 742.

For each row in the variable definition table 625, identification information of the row is registered as the vdid 741. A variable portion pattern defined by the administrator is registered as the variable definition 742. Specifically, a variable portion pattern is defined for the variable definition 742 with the use of a regular expression. In the first row of the variable definition table 625, a number string that is one letter long or longer is defined as a variable portion pattern of the process ID (PID) type. In the second row of the variable definition table 625, with an IP addresses in mind, a number string segmented by periods is defined as a variable portion pattern of the IP address type.

FIG. 8 is an explanatory diagram of the temporary common table 626 according to the first embodiment of this invention.

The temporary common table 626 temporarily stores the level of a log that does not match any common portion registered as the msg template 713 in the common table 622, and an unstructured portion of a log message of the log. The temporary common table 626 includes a tcid 751, a level 752, and an msg 753.

For each row in the temporary common table 626, identification information of the row is registered as the tcid 751. The level of a log that does not match any common portion registered as the msg template 713 in the common table 622 is registered as the level 752. A log message of the log that does not match any common portion registered as the msg template 713 in the common table 622 is registered as the msg 753.

The reconfiguration program 614 removes a variable portion from a log message stored in the temporary common table 626 at given timing, extracts other portions than the variable portion as a common portion, and stores the extracted common portion in the common table 622.

Alternatively, the storing program 613 may register, as the msg template 713 in the common table 622, a log message of a log that does not match any common portion registered as the msg template 713 in the common table 622, without changing the log message. The log management computer 101 in this case can manage the common table 622 and the temporary common table 626 as one table.

Log storing processing by the storing program 613 is described next with reference to FIG. 9 and FIG. 10.

FIG. 9 is a flow chart of log storing processing based on the variable definition table 625 according to the first embodiment of this invention. This storing processing is executed by the processor 606 by executing the storing program 613.

The storing processing is executed at the time when one line of log generated by one of the log generating systems 105 is obtained (1201). However, this invention is not limited thereto and the storing processing may be executed in given cycles, for example. In the case where the log management computer 101 obtains a given count of logs accumulated by the log collecting system 106, the log management computer 101 obtains one line of log from the obtained logs and then executes the storing processing.

The processor 606 first extracts a structured portion of the obtained log, and stores the extracted portion in the log table 621 (1202). Specifically, the processor 606 adds a new row to the log table 621, registers identification information of this row as the logid 701, registers a date/time that is included in the log as the datetime 702, and adds a host that is included in the log as the host 703. Nothing is registered as the cid 704 and the vids 705 in Step 1202.

The processor 606 next refers to the variable definition table 625 to extract, from the log message of the obtained log, as a variable portion, a portion that matches a variable portion definition registered in the variable definition table 625, and to extract other portions of the log message of the obtained log than the variable portion as a common portion (1203).

The processor 606 then determines whether or not the variable portion extracted in Step 1203 is registered as the variable 732 in the variable table 623 (1204).

When it is determined in Step 1204 that the variable portion extracted in Step 1203 is not registered as the variable 732 in the variable table 623, the processor 606 adds a new row to the variable table 623. In the added row, the processor 606 registers identification information of this row as the vid 731, registers the variable portion extracted in Step 1203 as the variable 732, and registers, as the logids 733, identification information that has been registered as the logid 701 in the added row of the log table 621 in Step 1202 (1205).

The processor 606 next adds, as the vids 705 in the row added to the log table 621 in Step 1202, the identification information that has been registered as the vid 731 in the row added to the variable table 623 in Step 1205 (1207).

When it is determined in Step 1204 that the variable portion extracted in Step 1203 is registered as the variable 732 in the variable table 623, on the other hand, the processor 606 registers the identification information that has been registered as the logid 701 in the row added to the log table 621 in Step 1202 as the logids 733 in a row of the variable table 623 where a variable portion registered as the variable 732 matches the variable portion extracted in Step 1203 (1206). The processor 606 then proceeds to Step 1207. In Step 1207 in this case, the processor 606 adds the identification information that has been added as the logids 733 of the variable table 623 in Step 1206 as the vids 705 of the row added to the log table 621 in Step 1202.

The processor 606 then determines whether or not the common portion extracted in Step 1203 is registered as the msg template 713 in the common table 622 (1208).

When it is determined in Step 1208 that the common portion extracted in Step 1203 is not registered as the msg template 713 in the common table 622, the processor 606 adds a new row to the common table 622. In the added row, the processor 606 registers identification information of this row as the cid 711, registers a level that is included in a log extracted as the common portion as the level 712, and registers a log message extracted as the common portion as the msg template 713 (1209).

The processor 606 then adds, as the cid 704 in the row added to the log table 621 in Step 1202, the identification information that has been registered as the cid 711 in the row added to the common table 622 in Step 1209 (1210).

When it is determined in Step 1208 that the common portion extracted in Step 1203 is registered as the msg template 713 in the common table 622, on the other hand, the processor 606 proceeds to Step 1210. In Step 1210, identification information registered as the cid 711 in a row of the common table 622 where a variable portion registered as the msg template 713 matches the common portion extracted in Step 1203 is registered as the cid 704 in the row added to the log table 621 in Step 1202.

The processor 606 next extracts a word that constitutes the variable portion extracted in Step 1203 (1211).

The processor 606 then determines whether or not the word extracted in Step 1211 is registered as the term 721 in the term table 624 (1212).

When it is determined in Step 1212 that the word extracted in Step 1211 is not registered as the term 721 in the term table 624, the processor 606 adds a new row to the term table 624. In the added row, the processor 606 registers the word extracted in Step 1211 as the term 721, and registers, as the cids 722, identification information registered as the cid 711 in a row of the common table 622 where a variable portion registered as the msg template 713 matches the variable portion from which the word has been extracted in Step 1211 (1213). The processor 606 then ends the processing.

When it is determined in Step 1212 that the word extracted in Step 1211 is registered as the term 721 in the term table 624, on the other hand, the processor 606 registers, as the cids 722 in a row of the term table 624 where a word registered as the term 721 matches the word extracted in Step 1211, identification information registered as the cid 711 in a row of the common table 622 where a variable portion registered as the msg template 713 matches the variable portion from which the word has been extracted in Step 1211 (1214). The processor 606 then ends the processing.

In the manner described above, common portions of logs are integrated to be stored in the common table 622 whereas variable portions of the logs are integrated to be stored in the variable table 623, and the capacity taken up by a log storage area is reduced as a result. In addition, a common portion stored in the common table 622 is associated with the log table 621 via the cid 711 and a variable portion stored in the variable table 623 is associated with the log table 621 via the vid 731, which enable the log management computer 101 to restore a fragment to its original log by referring to these tables.

FIG. 10 is a flow chart of log storing processing based on the common table 622 according to the first embodiment of this invention. This storing processing is executed by the processor 606 by executing the storing program 613.

Steps illustrated in FIG. 10 that are the same as those in FIG. 9 are denoted by the same symbols in order to omit their descriptions. The log management computer 101 only needs to execute one of the storing processing of FIG. 9 and the storing processing of FIG. 10 to store a log in the storage device 102.

The processor 606 first obtains in Step 1201 one line of log generated by one of the log generating systems 105. In Step 1202, the processor 606 extracts a structured portion of the obtained log and stores the extracted portion in the log table 621.

The processor 606 next determines whether or not a log message that is included in a log obtained in Step 1201 matches a common portion registered as the msg template 713 in the common table 622 (1301).

Specifically, the processor 606 determines whether or not a log message that is included in the log obtained in Step 1201 contains every letter string that constitutes one of common portions registered as the msg template 713 in the common table 622.

A case where “apache[%s] [client %s]: cannot find /var/www/favicon.ico” is registered as the msg template 713 in the first row of the common table 622 and the first line of the log of FIG. 27 is obtained in Step 1201 is described as an example. A log message of the first line of the log of FIG. 27 contains all of “apache” and “cannot find /var/www/favicon.ico” which are a common portion registered as the msg template 713 in the first row of the common table 622. Accordingly, it is determined in Step 1301 that the log message in the first line of the log of FIG. 27 matches the msg template 713 in the first row of the common table 622.

When it is determined in Step 1301 that a log message that is included in the log obtained in Step 1201 matches a common portion registered as the msg template 713 in the common table 622, the processor 606 extracts a variable portion from the log message that is included in the log obtained in Step 1201 (1302).

Specifically, the processor 606 extracts, as a variable portion, a portion that does not match the common portion registered as the msg template 713 in the common table 622 from the log message that is included in the log obtained in Step 1201.

The processor 606 next determines whether or not the variable portion extracted in Step 1302 is registered as the variable 732 in the variable table 623 (1304).

When it is determined in Step 1304 that the variable portion extracted in Step 1302 is not registered as the variable 732 in the variable table 623, the processor 606 adds a new row to the variable table 623. In the added row, the processor 606 registers identification information of this row as the vid 731, registers the variable portion extracted in Step 1302 as the variable 732, and registers, as the logids 733, identification information that has been registered as the logid 701 in the added row of the log table 621 in Step 1202 (1305).

The processor 606 next adds, as the vids 705 in the row added to the log table 621 in Step 1202, the identification information that has been registered as the vid 731 in the row added to the variable table 623 in Step 1305 (1307).

When it is determined in Step 1304 that the variable portion extracted in Step 1302 is registered as the variable 732 in the variable table 623, on the other hand, the processor 606 registers the identification information that has been registered as the logid 701 in the row added to the log table 621 in Step 1202 as the logids 733 in a row of the variable table 623 where a variable portion registered as the variable 732 matches the variable portion extracted in Step 1302 (1306). The processor 606 then proceeds to Step 1307. In Step 1307 in this case, the processor 606 adds the identification information that has been added as the logids 733 of the variable table 623 in Step 1306 as the vids 705 of the row added to the log table 621 in Step 1202.

When it is determined in Step 1301 that a log message that is included in the log obtained in Step 1201 does not match a common portion registered as the msg template 713 in the common table 622, the processor 606 registers the level and log message of the log obtained in Step 1201 in the temporary common table 626 (1303), and ends the processing.

Also in the storing processing of FIG. 10, common portions of logs are integrated to be stored in the common table 622 whereas variable portions of the logs are integrated to be stored in the variable table 623 as in the storing processing of FIG. 9, and the capacity taken up by a log storage area is thus reduced. In addition, a common portion stored in the common table 622 is associated with the log table 621 via the cid 711 and a variable portion stored in the variable table 623 is associated with the log table 621 via the vid 731, which enable the log management computer 101 to restore a fragment to its original log by referring to these tables.

While the method described above with reference to FIG. 9 uses the variable definition table 625 to extract a variable portion and a common portion from a log and the method described above with reference to FIG. 10 uses a common portion stored in the common table 622 to extract a variable portion and a common portion from a log, there are other methods that can be used to extract a variable portion and a common portion from a log.

For instance, in one possible method, the administrator defines a form that indicates where in a log a variable portion is located, and the definition is used to extract a variable portion and a common portion from a log. The administrator may set a definition of the form after viewing a stored log, or may set a definition of the form first.

The form of a common portion and a variable portion can also be defined by analyzing with a computer a source code of a program that outputs a log. Details thereof are described in a literature (Wei Xu et al., “Detecting Large-Scale System Problems by Mining Console Logs”, in Proceedings of the 22^{nd} ACM Symposium on Operating Systems Principles (SOSP '09), 2009). Instead of defining the form of a common portion and a variable portion, a program that extracts a common portion and a variable portion may be called up externally when the storing program 613 obtains a log message.

Log search processing by the search program 615 is described next with reference to FIG. 11 to FIG. 15.

FIG. 11 is a flow chart of search processing according to the first embodiment of this invention. This search processing is executed by the processor 606 by executing the search program 615.

The search processing is executed when the log management computer 101 receives a search request transmitted from one of the client terminals 140 (1501). The search request contains a search criterion. In the case where the search request contains a keyword “apache” as a search criterion, the search processing involves searching for every log that includes “apache” in a log message and transmitting the result of the search to the client terminal 104. Other than a keyword, criteria about the date/time and the log level may be included in search criteria. For example, when search criteria include a keyword “apache”, a date/time “from Jan. 1, 2011 to Apr. 2, 2011”, and a host name “host1”, the log management computer 101 transmits every log that meets all of the search criteria, the keyword, the date/time, and the host name, to the client terminal 104 as the result of the search. Search criteria are not limited to a keyword, a date/time, a host name, and the like, and may not include some of the criteria such as a keyword.

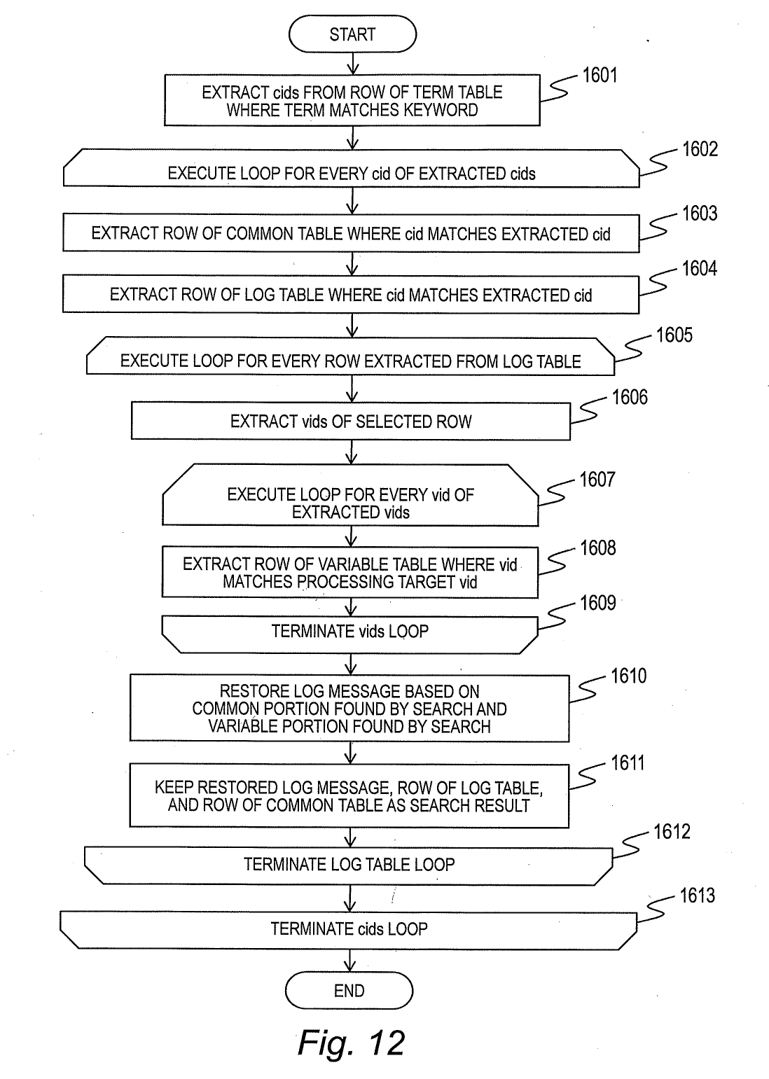

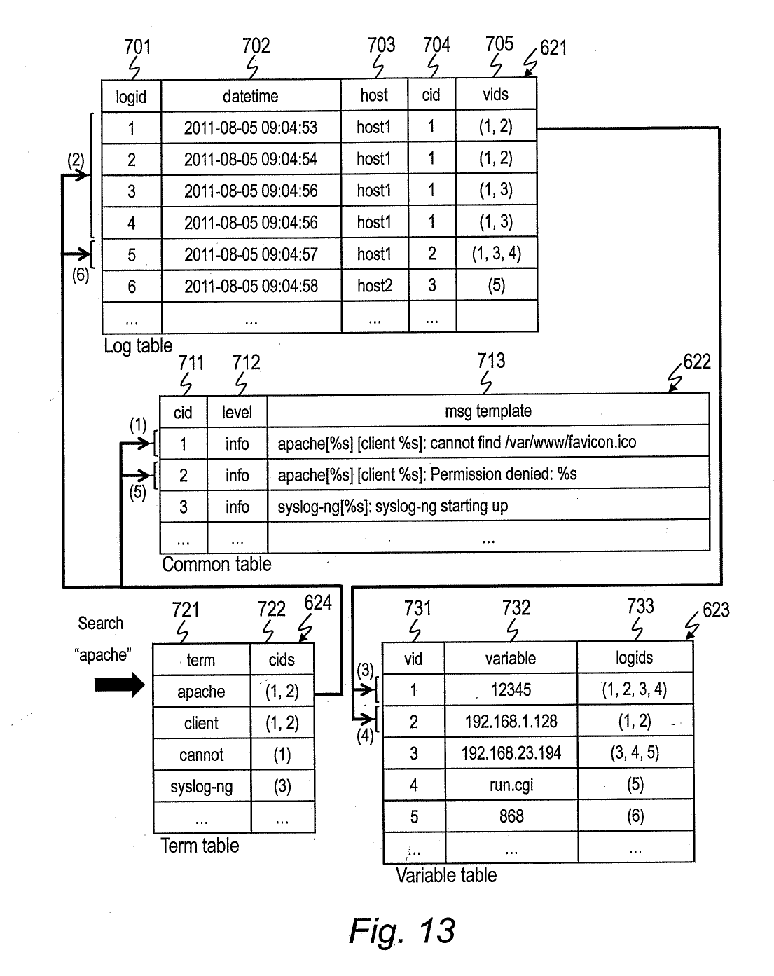

The processor 606 first refers to the term table 624 to search for logs that meet search criteria included in a received search request (1502). Details of Step 1502 are described with reference to FIG. 12 and FIG. 13.

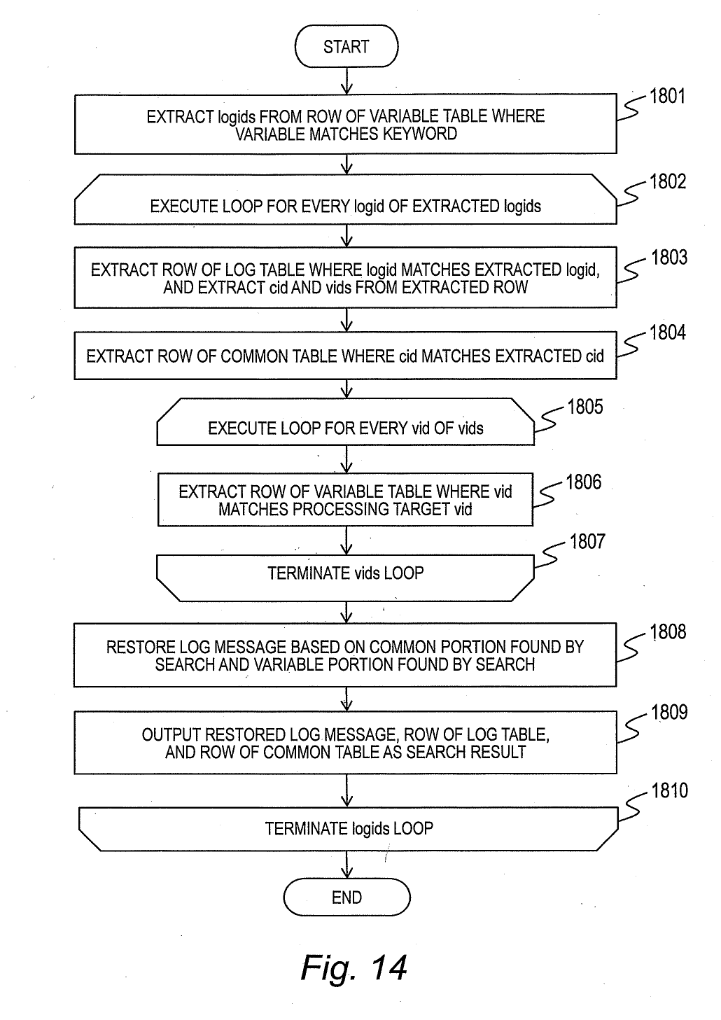

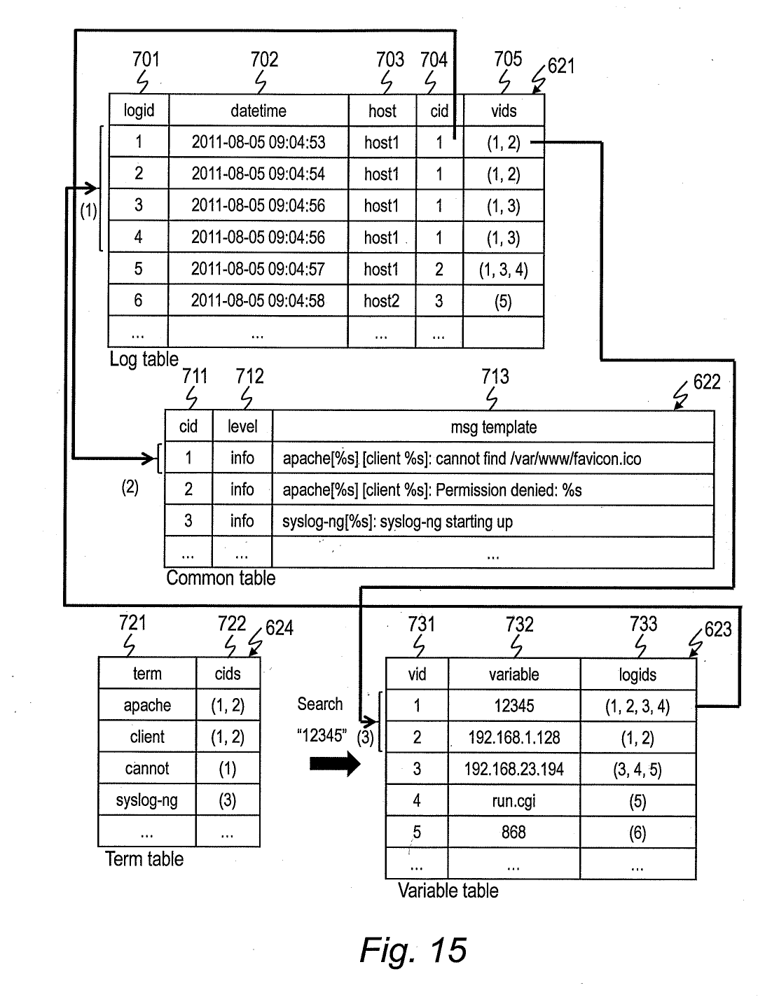

The processor 606 next refers to the variable table 623 to search for logs that meet the search criteria included in the received search request (1503). Details of Step 1503 are described with reference to FIG. 14 and FIG. 15.

The processor 606 next transmits the logs found in Step 1502 and the logs found in Step 1503 to the relevant client terminal 104 as the result of the search (1504), and ends the processing. The client terminal 104 displays the received search result on an output device such as a display (not shown).

In Step 1504, the processor 606 may output the search result in a file format or a similar format to a storage device or the like, instead of transmitting the search result to the client terminal 104 so that the search result is displayed.

The order in which Step 1502 and Step 1503 are executed may be switched, or Step 1502 and Step 1503 may be executed simultaneously.

Step 1502 (search processing based on the term table 624) is described with reference to FIG. 12 and FIG. 13.

FIG. 12 is a flow chart of the search processing based on the term table 624 according to the first embodiment of this invention.

The processor 606 first extracts every cid registered as the cids 722 from a row of the term table 624 where a word registered as the term 721 matches a keyword included in the search request (1601).

From the cids extracted in Step 1601, the processor 606 selects one cid for which Steps 1603 to 1613 have not been executed, and repeatedly executes Steps 1602 to 1613 until executing Steps 1603 to 1613 is finished for every cid extracted in Step 1601 (1602).

The processor 606 next extracts any row of the common table 622 where a cid registered as the cid 711 matches the cid selected in Step 1602 (1603).

The processor 606 next extracts any row of the log table 621 where a cid registered as the cid 704 matches the cid selected in Step 1602 (1604).

From the rows extracted in Step 1604, the processor 606 next selects one row for which Steps 1606 to 1612 have not been executed, and repeatedly executes Steps 1605 to 1612 until executing Steps 1606 to 1612 is finished for every row extracted in Step 1604 (1605).

The processor 606 next extracts every vid registered as the vids 705 from the row of the log table 621 that has been selected in Step 1605 (1606).

From the vids extracted in Step 1606, the processor 606 next selects one vid for which Steps 1608 and 1609 have not been executed, and repeatedly executes Steps 1607 to 1609 until executing Steps 1608 and 1609 is finished for every vid extracted in Step 1606 (1607).

The processor 606 next extracts any row of the variable table 623 where a vid registered as the vid 731 matches the vid selected in Step 1607 (1608).

In the case where executing Steps 1608 and 1609 has been finished for every vid extracted in Step 1606, the processor 606 proceeds to Step 1610. In the case where executing Steps 1608 and 1609 has not been finished for every vid extracted in Step 1606, the processor 606 returns to Step 1607 (1609).

The processor 606 next restores a log message to the state prior to the extraction of a variable portion and a common portion based on a common portion registered as the msg template 713 in the common table 622 that has been extracted in Step 1603 and a variable portion registered as the variable 732 in the variable table 623 that has been extracted in Step 1608 (1610).

Specifically, the processor 606 restores a log message to the state prior to the extraction of a variable portion and a common portion by identifying which part of a common portion registered as the msg template 713 in the common table 622 that has been extracted in Step 1603 indicates the previous existence of a variable portion, and embedding a variable portion registered as the variable 732 in the variable table 623 that has been extracted in Step 1608 in the identified part in an order in which vids are registered as the vids 705 in the row of the log table 621 that has been selected in Step 1605.

The processor 606 next restores a log by attaching, to the log message restored in Step 1610, a structured portion of the log registered in the row of the log table 621 that has been selected in Step 1605 and a level registered as the level 712 in a row of the common table 622 that has been extracted in Step 1603, and keeps the restored log as a search result (1611).

In the case where executing Steps 1606 to 1612 has been finished for every row of the log table 621 extracted in Step 1604, the processor 606 proceeds to Step 1613. In the case where executing Steps 1606 to 1612 has not been finished for every row of the log table 621 extracted in Step 1604, the processor 606 returns to Step 1605 (1612).

In the case where executing Steps 1603 to 1613 has been finished for every cid extracted in Step 1601, the processor 606 ends the processing. In the case where executing Steps 1603 to 1613 has not been finished for every cid extracted in Step 1601, the processor 606 returns to Step 1602 (1613).

FIG. 13 is an explanatory diagram of the search processing based on the term table 624 according to the first embodiment of this invention.

A search request in FIG. 13 contains “apache” as a keyword.

In Step 1601, cids (1, 2) registered as the cids 722 in the first row and second row of the term table 624 are extracted.

In Step 1602, cid (1) is selected from cids (1, 2) extracted in Step 1601.

In Step 1603, the first row of the common table 622 where cid (1) selected in Step 1602 is registered as the cid 711 is extracted as illustrated in (1) of FIG. 13.

In Step 1604, the first row to fourth row of the log table 621 where cid (1) selected in Step 1602 is registered as the cid 704 are extracted as illustrated in (2) of FIG. 13.

In Step 1605, the first row is selected from the first row to fourth row of the log table 621 extracted in Step 1604.

In Step 1606, every one of vids (1, 2) registered as the vids 705 in the first row of the log table 621 selected in Step 1605 is extracted.

In Step 1607, vid (1) is selected from vids (1, 2) extracted in Step 1606.

In Step 1608, the first row of the variable table 623 where vid (1) selected in Step 1607 is registered as the vid 731 is extracted as illustrated in (3) of FIG. 13.

In Step 1609, executing Steps 1608 and 1609 has not been finished for every one of vids (1, 2) extracted in Step 1606. The processor 606 therefore returns to Step 1607 and selects vid (2).

In Step 1608, the second row of the variable table 623 where vid (2) selected in Step 1607 executed for the second time is registered as the vid 731 is extracted as illustrated in (4) of FIG. 13.

In Step 1609 executed for the second time, executing Steps 1608 and 1609 has been finished for every one of vids (1, 2) extracted in Step 1606. The processor 606 therefore proceeds to Step 1610.

In Step 1610, a log message “apache[12345] [client 192.168.1.128]: cannot find/var/www/favicon.ico” is restored based on a common portion “apache[%s] [client %s]: cannot find/var/www/favicon.ico” registered as the msg template 713 in the first row of the common table 622 which has been extracted in Step 1603, and variable portions [12345] and [192.168.1.128] registered as the variable 732 in the first row and second row of the variable table 623 which have been extracted in Step 1608.

In Step 1611, a datetime “2011-08-05 09:04:53”, a level “info”, and a host “host1” are attached to the log message “apache[12345] [client 192.168.1.128]: cannot find/var/www/favicon.ico”, to thereby restore the original log “2011-08-05 09:04:53, info, host1, apache[12345] [client 192.168.1.128]: cannot find/var/www/favicon.ico”.

In Step 1612, executing Steps 1606 to 1612 has not been finished for the second row to fourth row of the log table 621 which have been extracted in Step 1604. The processor 606 therefore returns to Step 1605, where the second row of the log table 621 is selected.

When executing Steps 1606 to 1612 is finished for the first row to fourth row of the log table 621, the processor 606 proceeds to Step 1613.

In Step 1613, executing Steps 1603 to 1613 has not been finished for cids (2) extracted in Step 1601. The processor 606 therefore returns to Step 1602.

In Step 1602, cid (2) for which Steps 1603 to 1613 have not been executed is selected from cids (1, 2) extracted in Step 1601.

In Step 1603, the second row of the common table 622 where cid (2) selected in Step 1602 is registered as the cid 711 as illustrated in (5) of FIG. 13.

In Step 1604, the fifth row of the log table 621 where cid (2) selected in Step 1602 is registered as the cid 704 as illustrated in (6) of FIG. 13.

Subsequently, Steps 1606 to 1613 are executed for the fifth row of the log table 621 which has been extracted in Step 1604, and then the processing is ended.

A word that matches a keyword contained in a search request is thus searched for from among words registered in the term table 624, instead of searching the entirety of a log message for a word that matches a keyword contained in a search request, and the search efficiency is improved as a result.

Step 1503 (search processing based on the variable table 623) is described with reference to FIG. 14 and FIG. 15.

FIG. 14 is a flow chart of the search processing based on the variable table 623 according to the first embodiment of this invention.

The processor 606 first extracts a logid registered as the logids 733 from a row of the variable table 623 where a variable portion registered as the variable 732 matches a keyword contained in the search request (1801).

From the logids extracted in Step 1801, the processor 606 selects one logid for which Steps 1803 to 1810 have not been executed, and repeatedly executes Steps 1802 to 1810 until executing Steps 1803 to 1810 is finished for every logid extracted in Step 1801 (1802).

The processor 606 next extracts a cid registered as the cid 704 and a vid registered as the vids 705 from a row of the log table 621 where a logid registered as the logid 701 matches the logid selected in Step 1802 (1803).

The processor 606 next extracts any row of the common table 622 where a cid registered as the cid 711 matches the cid selected in Step 1803 (1804).

From the vids extracted in Step 1803, the processor 606 selects one vid for which Steps 1806 and 1807 have not been executed, and repeatedly executes Steps 1805 to 1807 until executing Steps 1806 and 1807 is finished for every vid extracted in Step 1803 (1805).

The processor 606 next extracts any row of the variable table 623 where a vid registered as the vid 731 matches the vid selected in Step 1805 (1806).

In the case where executing Steps 1806 and 1807 has been finished for every vid extracted in Step 1803, the processor 606 proceeds to Step 1808. In the case where executing Steps 1806 and 1807 has not been finished for every vid extracted in Step 1803, the processor 606 returns to Step 1805 (1807).

The processor 606 next restores a log message to the state prior to the extraction of a variable portion and a common portion based on a common portion registered as the msg template 713 in the common table 622 that has been extracted in Step 1804 and a variable portion registered as the variable 732 in the variable table 623 that has been extracted in Step 1806 (1808). Details of Step 1808 are the same as those of Step 1610 illustrated in FIG. 12, and a description thereof is omitted.

The processor 606 next restores a log by attaching, to the log message restored in Step 1808, a structured portion of the log registered in the row of the log table 621 that has been extracted in Step 1803 and a level registered as the level 712 in a row of the common table 622 that has been extracted in Step 1804, and keeps the restored log as a search result (1809). Details of Step 1809 are the same as those of Step 1611 illustrated in FIG. 12, and a description thereof is omitted.

In the case where executing Steps 1803 to 1810 has been finished for every logid extracted in Step 1801, the processor 606 ends the processing. In the case where executing Steps 1803 to 1810 has not been finished for every logid extracted in Step 1801, the processor 606 returns to Step 1802 (1810).

FIG. 15 is an explanatory diagram of the search processing based on the variable table 623 according to the first embodiment of this invention.

A search request in FIG. 15 contains “12345” as a keyword.

In Step 1801, logids (1, 2, 3, 4) registered as the logids 733 in the first row of the variable table 623 are extracted.

In Step 1802, logid (1) is selected from logids (1, 2, 3, 4) extracted in Step 1801.

In Step 1803, cid (1) registered as the cid 704 and vids (1, 2) registered as the vids 705 are extracted from the first row of the log table 621 where logid (1) selected in Step 1802 is registered as the logid 701. With logids (1, 2, 3, 4) extracted in Step 1801, the first row to fourth row of the log table 621 are ultimately extracted in Step 1803 as illustrated in (1) of FIG. 15.

In Step 1804, the first row of the common table 622 where cid (1) extracted in Step 1803 is registered as the cid 711 is extracted as illustrated in (2) of FIG. 15.

In Step 1805, vid (1) is selected from vids (1, 2) extracted in Step 1803.

In Step 1806, the first row of the variable table 623 where vid (1) selected in Step 1805 is registered as the vid 731 is extracted.

In Step 1807, executing Steps 1806 and 1807 has not been finished for vid (2) extracted in Step 1803. The processor 606 therefore returns to Step 1805 and selects vid (2) that has been extracted in Step 1803.

In Step 1806 executed for the second time, the second row of the variable table 623 where vid (2) selected in Step 1805 is registered as the vid 731 is extracted. In Step 1807, executing Steps 1806 and 1807 has been finished for vids (1, 2) extracted in Step 1803. The processor 606 therefore proceeds to Step 1808.

In Step 1808, a log message “apache[12345] [client 192.168.1.128]: cannot find/var/www/favicon.ico” is restored based on a common portion “apache[%s] [client %s]: cannot find/var/www/favicon.ico” registered as the msg template 713 in the first row of the common table 622 which has been extracted in Step 1804, and variable portions [12345] and [192.168.1.128] registered as the variable 732 in the first row and second row of the variable table 623 which have been extracted in Step 1806.

In Step 1809, a datetime “2011-08-05 09:04:53”, a level “info”, and a host “host1” are attached to the log message “apache[12345] [client 192.168.1.128]: cannot find/var/www/favicon.ico”, to thereby restore the original log “2011-08-05 09:04:53, info, host1, apache[12345] [client 192.168.1.128]: cannot find/var/www/favicon.ico”.

In Step 1810, executing Steps 1802 to 1810 has not been finished for logids (2, 3, 4) extracted in Step 1801. The processor 606 therefore returns to Step 1802 to repeatedly execute Steps 1802 to 1810 until executing Steps 1802 to 1810 is finished for logids (1, 2, 3, 4) extracted in Step 1801.

A word that matches a keyword contained in a search request is thus searched for from among variable portions registered in the variable table 623, instead of searching the entirety of a log message for a word that matches a keyword contained in a search request, and the search efficiency is improved as a result.

Described next with reference to FIG. 16 to FIG. 19 is reconfiguration processing in which the reconfiguration program 614 reconfigures logs stored in the temporary common table 626.

FIG. 16 is a flow chart of the reconfiguration processing by the reconfiguration program 614 according to the first embodiment of this invention.

The reconfiguration processing is executed by the processor 606 by executing the reconfiguration program 614 at given timing. The given timing is, for example, the time when the count of logs stored in the temporary common table 626 reaches a given count or higher, or a given cycle, or the time when the administrator inputs a command to execute the reconfiguration processing.

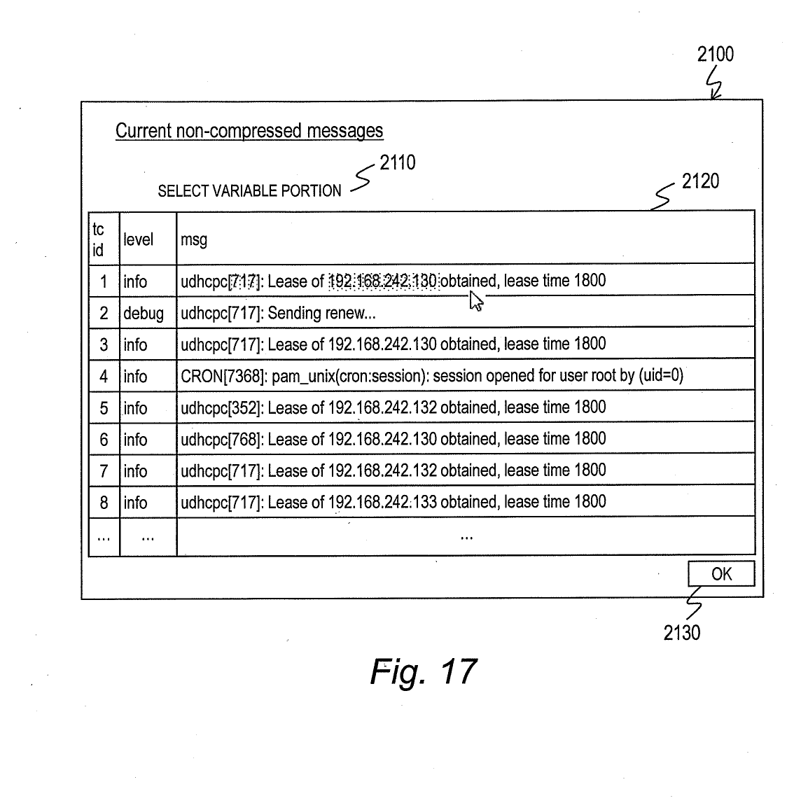

The processor 606 first has the administrator terminal 103 display a log displaying screen 2100 illustrated in FIG. 17 which includes logs stored in the temporary common table 626, and receives the specification of a variable portion from the administrator via the log displaying screen 2100 (2001). Specifically, the processor 606 transmits to the administrator terminal 103 a log displaying screen displaying command which is a command to the administrator terminal 103 to display the log displaying screen 2100. Receiving the log displaying screen displaying command, the administrator terminal 103 displays the log displaying screen 2100 on an output device (not shown).

In the case where the administrator can operate the log management computer 101 directly or other similar cases, the processor 606 may display the log displaying screen 2100 on the input/output device 608.

The log displaying screen 2100 is described with reference to FIG. 17. FIG. 17 is an explanatory diagram of the log displaying screen 2100 according to the first embodiment of this invention.

The log displaying screen 2100 includes a message displaying area 2110, a log displaying area 2120, and an OK button 2130.

The message displaying area 2110 displays a message that prompts the administrator to specify a variable portion (“select a variable portion”). The log displaying area 2120 displays logs stored in the temporary common table 626. The administrator looks at the logs displayed in the log displaying area 2120, and specifies a variable portion. FIG. 17 illustrates a state in which “717” and “192.168.242.130” in a log message included in a log are specified as variable portions. The administrator may specify one variable portion or a plurality of variable portions.

The OK button 2130 is operated by the administrator when entering a specified variable portion to the log management computer 101.

Returning to FIG. 16, Step 2002 and subsequent steps are described.

The processor 606 receives the specification of a variable portion by the administrator and extracts, from the log that contains the specified variable portion, the specified variable portion and a common portion, which is the remainder after extracting the specified variable portion (2002).

The processor 606 next selects a log that matches the common portion extracted in Step 2002 from the logs stored in the temporary common table 626 (2003). Specifically, the processor 606 selects, as a log that matches the common portion extracted in Step 2002, a log that contains all of the common portions extracted in Step 2002. The processor 606 also extracts, from the selected log, as a variable portion, a portion different from the common portion extracted in Step 2002.

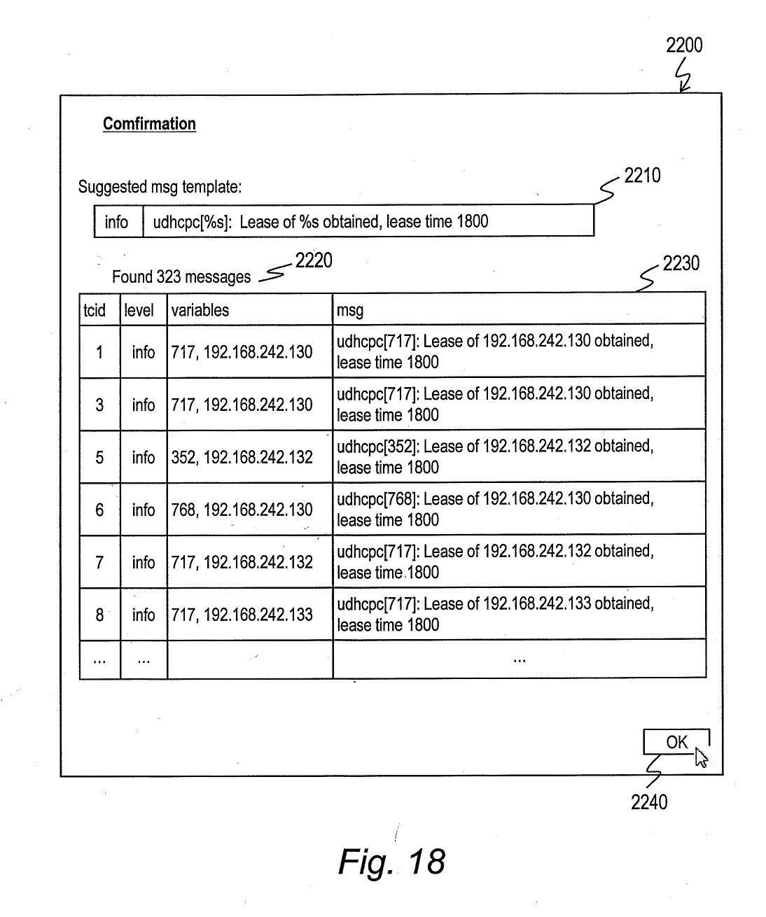

The processor 606 next has the administrator terminal 103 display a confirmation screen 2200 illustrated in FIG. 18 which displays a log selected in Step 2003 (2004). Specifically, the processor 606 transmits to the administrator terminal 103 a confirmation screen displaying command which is a command to the administrator terminal 103 to display the confirmation screen 2200. Receiving the confirmation screen displaying command, the administrator terminal 103 displays the confirmation screen 2200 on the output device (not shown).

The confirmation screen 2200 is described with reference to FIG. 18. FIG. 18 is an explanatory diagram of the confirmation screen 2200 according to the first embodiment of this invention.

The confirmation screen 2200 includes a common portion displaying area 2210, a selected log count displaying area 2220, a selected log displaying area 2230, and an OK button 2240.

The common portion displaying area 2210 displays a common portion selected in Step 2002. The selected log count displaying area 2220 displays the count of logs selected in Step 2003 from logs stored in the temporary common table 626. The selected log displaying area 2230 displays a level, a variable portion, and a log message for each log selected in Step 2003 from logs stored in the temporary common table 626. Logs selected in Step 2003 are logs whose variable portions and common portions can respectively be integrated to be managed.

The OK button 2240 is operated by the administrator when confirming a specified variable portion and registering the specified variable portion and a common portion which is extracted based on the variable portion in their respective tables.

Returning to FIG. 16, Step 2005 and subsequent steps are described.

The processor 606 determines whether or not information has been received that indicates that the OK button 2240 has been operated on the confirmation screen 2200 (2005).

When it is determined in Step 2005 that information indicating that the OK button 2240 has been operated on the confirmation screen 2200 has been received, the processor 606 executes common table storing processing in which the common portion extracted in Step 2002 and the common portion selected in Step 2003 are stored in the common table 622 (2006). The common table storing processing is the same as Steps 1208 to 1210 illustrated in FIG. 9, and a description thereof is omitted.

The processor 606 next executes term table storing processing in which words that constitute the common portion extracted in Step 2002 and the common portion selected in Step 2003 are stored in the term table 624 (2007). The term table storing processing is the same as Steps 1211 to 1214 illustrated in FIG. 9, and a description thereof is omitted.

The processor 606 next executes variable table storing processing in which the variable portion extracted in Step 2002 and the variable portion selected in Step 2003 are stored in the variable table 623. The variable table storing processing is the same as Steps 1204 to 1207 illustrated in FIG. 9, and a description thereof is omitted.

When it is determined in Step 2005 that information indicating that the OK button 2240 has been operated on the confirmation screen 2200 has not been received, the processor 606 ends the reconfiguration processing.

The confirmation screen 2200 may include a cancel button so that, when information indicating that the cancel button has been operated is received after Step 2004, the processor 606 returns to Step 2001 to display the log displaying screen 2100 again and repeatedly execute the reconfiguration processing until the administrator deems it enough.

In Step 2001, the processor 606 may display common portions stored in the common table 622 to prompt the administrator to specify a new variable portion. In this way, logs whose common portions and variable portions are respectively integrated once to be stored are integrated further, with the result that the capacity taken up by stored logs is further reduced.

According to this embodiment, the capacity taken up by stored logs is thus reduced by extracting common portions and variable portions from log messages which are unstructured portions contained in logs, and integrating the common portions to be stored in the common table 622 and integrating the variable portions to be stored in the variable table 623. In addition, because the common table 622 and the variable table 623 are associated with each other, an original log can be restored by combining a common portion and a variable portion, and the search processing time is cut short. The search processing time is also cut short by searching with the use of the term table 624.

### Second Embodiment

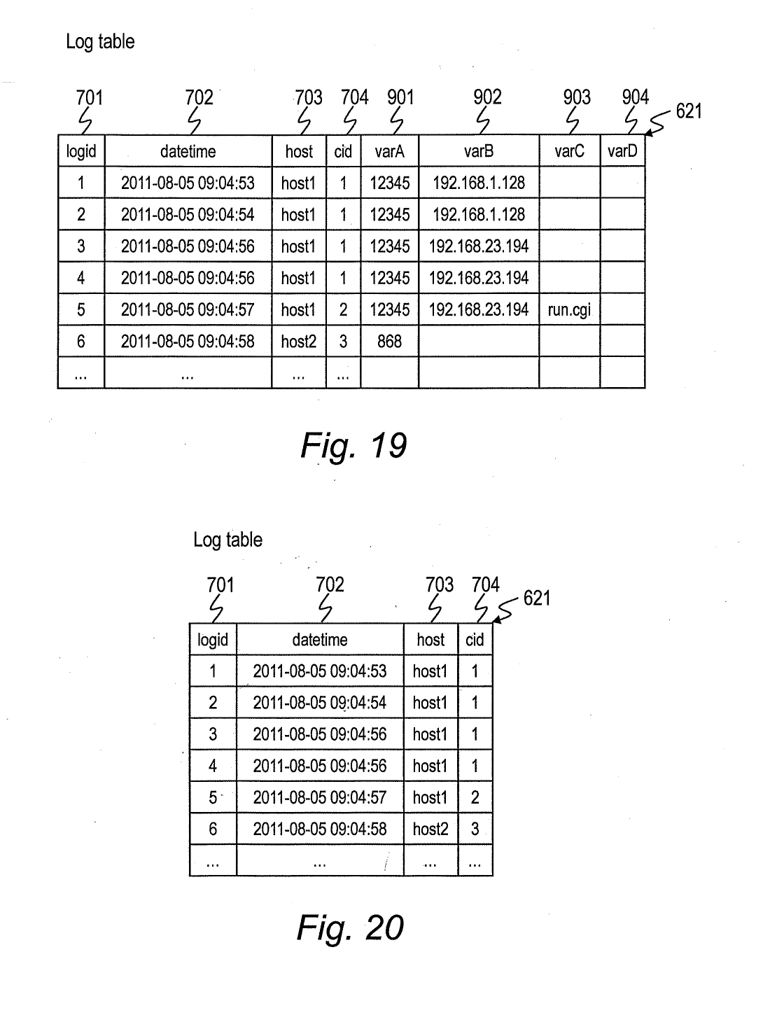

A second embodiment of this invention is described with reference to FIG. 19.

In this embodiment, a variable portion is registered for each log in the log table 621, which eliminates the need for the storage device 102 to store the variable table 623.

FIG. 19 is an explanatory diagram of the log table 621 according to the second embodiment of this invention.

The log table 621 includes the logid 701, the datetime 702, the host 703, the cid 704, a varA 901, a varB 902, a varC 903, and a varD 904. The logid 701, the datetime 702, the host 703, and the cid 704 are the same as those in the log table 621 of the first embodiment which is illustrated in FIG. 3, and descriptions thereof are omitted here.

In the log table 621 of FIG. 19, the maximum count of variable portions that can be stored per log is 4, and the variable portions are registered as the varA 901 to the varD 904.

Search processing in this embodiment is quicker than in the first embodiment because there is no need to combine a structured portion of a log stored in the log table 621 and a variable portion stored in the variable table 623 in Step 1611 of FIG. 12 and Step 1809 of FIG. 14. On the other hand, the count of variable portions that can be stored in the log table 621 per log needs to be set in advance in this embodiment. If the count of variable portions that can be stored in the log table 621 per log is low, extracting a variable portion and a common portion from a log cannot be conducted efficiently. If the count of variable portions that can be stored in the log table 621 per log is too high, the log table 621 becomes sparse with an excess storage capacity wasted in a row that holds only a few variable portions.

### Third Embodiment

A third embodiment of this invention is described with reference to FIG. 20 to FIG. 22.

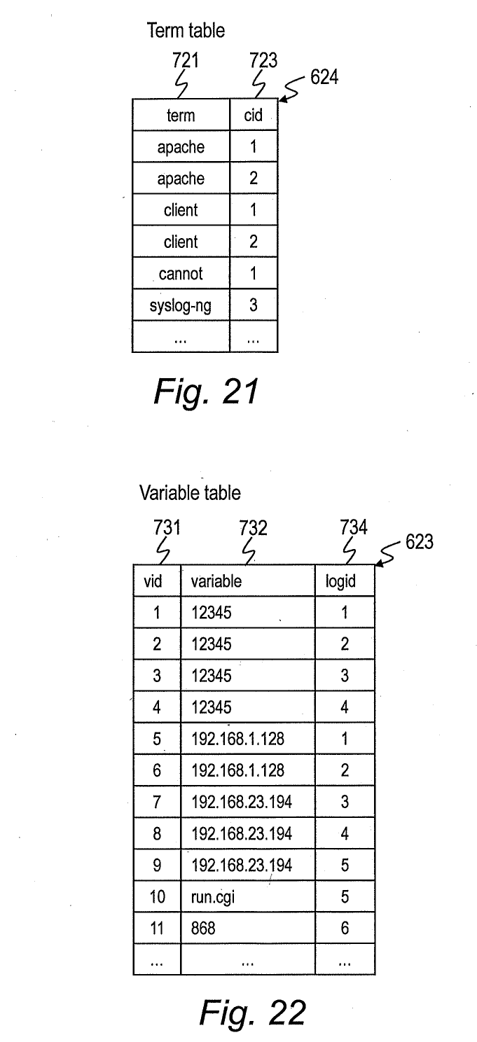

In the term table 624 of the first embodiment which is illustrated in FIG. 5 and the variable table 623 of the first embodiment which is illustrated in FIG. 6, row numbers are registered in the form of a list as the cids 722 and as the logids 733. In this embodiment, only one row number is registered as a cid 723 of the term table 624 as illustrated in FIG. 21 and as a logid 734 of the variable table 623 as illustrated in FIG. 22, and as many rows as the count of associated row numbers are added to the tables.

FIG. 20 is an explanatory diagram of the log table 621 according to the third embodiment of this invention.

The log table 621 according to the third embodiment of this invention does not need to include the vids 705. This is because a row number in the log table 621 which is registered as the logids 734 in the variable table 623 associates a variable portion stored in the variable table 623 and a structured portion of a log stored in the log table 621 on a one-on-one basis, and a variable portion contained in a log can be found by searching a row of the log table 621 that is identified by identification information registered as the logid 734 in the variable table 623.

FIG. 21 is an explanatory diagram of the term table 624 according to the third embodiment of this invention.

The term table 624 includes the term 721 and the cid 723. Registered as the cid 723 is identification information of one row of the common table 622 that indicates one common portion from which a word registered as the term 721 is extracted. For example, “apache” is extracted from common portions of the first row and second row of the common table 622, and the common portions are registered in two rows in the term table 624.

FIG. 22 is an explanatory diagram of the variable table 623 according to the third embodiment of this invention.

The variable table 623 includes the vid 731, the variable 732, and the logid 734. Registered as the logid 734 is identification information of one row of the log table 621 that indicates one log from which a variable portion registered as the variable 732 is extracted. For example, “12345” is extracted from logs of the first row to fourth row of the log table 621, and the logs are registered in four lines in the variable table 623.

### Modification Example of the Third Embodiment

In the term table 624 of the third embodiment which is illustrated in FIG. 21, the same word extracted from a plurality of common portions is registered in a plurality of rows. In this modification example of the third embodiment, a word extracted from a common portion is assigned identification information, and the identification information of the word is associated with identification information of the common portion.

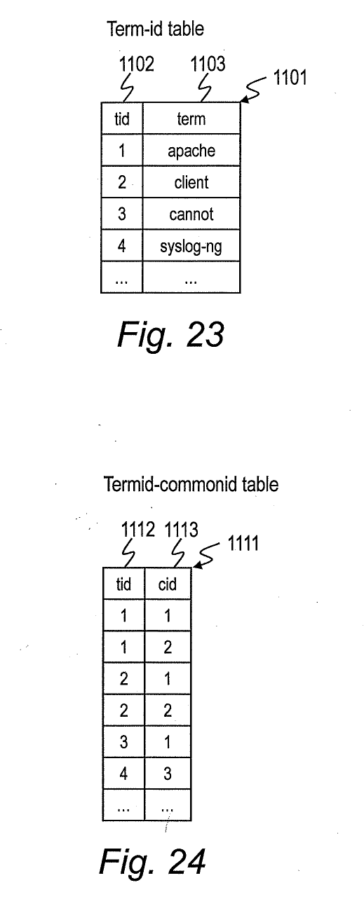

FIG. 23 is an explanatory diagram of a term-ID table 1101 according to the modification example of the third embodiment of this invention.

The term-ID table 1101 is a table for managing a word extracted from a common portion and identification information of the word, and includes a tid 1102 and a term 1103.

Identification information assigned to a word is registered as the tid 1102. The word extracted from a common portion is registered as the term 1103.

FIG. 24 is an explanatory diagram of a termid-commonid table 1111 according to the modification example of the third embodiment of this invention.

The termid-commonid table 1111 is a table for managing identification information assigned to a word and identification information of a row of the common table 622 where a common portion is stored, and includes a tid 1112 and a cid 1113.

Identification information assigned to a word is registered as the tid 1112. Identification information of a row of the common table 622 where a common portion is stored is registered as the cid 1113.

This eliminates the need to store the same letter string redundantly in the term table 624, and the capacity required for storage is accordingly reduced.

In the variable table 623 of the third embodiment which is illustrated in FIG. 22, the same variable portion is registered in a plurality of rows as in the term table 624 of FIG. 21. The variable table 623 may also be made up of a variable-ID table (not shown) for managing a variable portion and identification information of the variable portion, and a variableid-logid table (not shown) for managing the identification information of the variable portion and identification information of a row of the log table that stores a log from which the variable portion is extracted. This eliminates the need to store the same letter string redundantly in the variable table 623, and the capacity required for storage is accordingly reduced.

### Fourth Embodiment

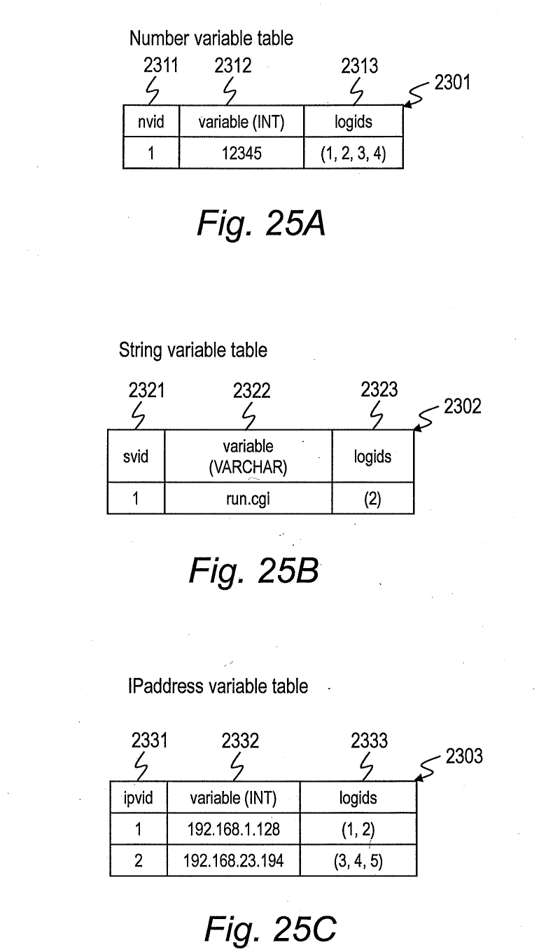

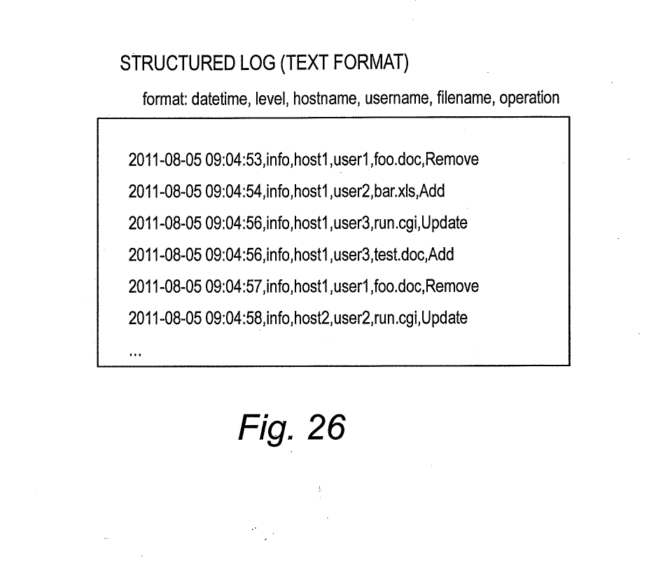

A fourth embodiment of this invention is described with reference to FIG. 25A to FIG. 25C.

In the fourth embodiment of this invention, different types of variable portions are stored in different tables. In this way, when a received search request contains as search criteria the type of a variable portion and the variable portion, search processing can be sped up by searching a table that corresponds to the variable portion type given as the search criterion.

In this embodiment, the types of variable portions defined in the variable definition table 625 of FIG. 7 are a given number string, an IP address, and a given letter string.

FIG. 25A is an explanatory diagram of a number variable table 2301 according to the fourth embodiment of this invention in which the type of a variable portion is a number string.

The number variable table 2301 includes an nvid 2311, a variable 2312, and logids 2313.

Identification information of a row of the number variable table 2301 is registered as the nvid 2311. A variable portion extracted as a match to a given number string is registered as the variable 2312 in an INT format. Identification information of a row of the log table 621 that stores a log from which the variable portion is extracted is registered as the logids 2313.

FIG. 25B is an explanatory diagram of a string variable table 2302 according to the fourth embodiment of this invention in which the type of a variable portion is a letter string.

The string variable table 2302 includes an svid 2321, a variable 2322, and logids 2323.

Identification information of a row of the string variable table 2302 is registered as the svid 2321. A variable portion extracted as a match to a given letter string is registered as the variable 2322 in a string format. Identification information of a row of the log table 621 that stores a log from which the variable portion is extracted is registered as the logids 2323.

FIG. 25C is an explanatory diagram of an IPaddress variable table 2303 according to the fourth embodiment of this invention in which the type of a variable portion is an IP address.

The IPaddress variable table 2303 includes an ipvid 2331, a variable 2332, and logids 2333.

Identification information of a row of the IPaddress variable table 2303 is registered as the ipvid 2331. A variable portion extracted as a match to an IP address format is registered as the variable 2332 in an INT format. An IP address registered as the variable 2332 can have an integer format because numerical values separated by periods can be expressed in 2-byte numerical values, and an IP address can be expressed in an 8-byte integer format. Identification information of a row of the log table 621 that stores a log from which the variable portion is extracted is registered as the logids 2333.

Preparing different tables as tables to store different types of variable portions in this manner makes it possible to specify a numerical value range when a numerical value is included as a search criterion. This enables one to conduct a search of log messages that contain, for example, a numerical value of 100 or larger, and searching log messages containing IP addresses from 192.168.23.110 to 192.168.23.130 is made possible.

In addition, in the case of storing a variable portion that is the IP address type, storing the IP address in an integer format requires a lower byte count than when the IP address is stored as a letter string, and the capacity required for storage is reduced that much.

The search program 615 in the search processing of this embodiment only needs to identify the type of a keyword contained in a search request in Step 1801 of FIG. 14 and search the variable table 623 that corresponds to the identified type. For instance, when a keyword contained in a search request indicates an IP address, the search program 615 only needs to search the IPaddress variable table 2303. Searching all of the variable tables 623 is thus unnecessary, which cuts short the search time.

As has been described, this invention reduces the capacity taken up by stored logs in management of unstructured logs that include a diversity of messages, and a search target log can quickly be searched for from among stored logs.

This invention has now been described in detail with reference to the accompanying drawings. However, this invention is not limited to those concrete configurations, and encompasses various modifications and equivalent configurations that are within the spirit of the accompanying scope of claims.

This invention is applicable to a log management computer for storing a log that is obtained from a log generating system for generating a log which is an operation record.

What is claimed is:

1. A log management computer for managing a log that is obtained from a log generating system for generating a log which is an operation record, comprising:
a storage area for storing the obtained log; and
a processor which refers to the log stored in the storage area,
wherein the processor is configured to:
extract, from a log message which is included in the log obtained from the log generating system, a common portion which is common to the log message and other log messages and a different portion which differs from other log messages;
store the extracted common portion in common portion information of the storage area;
store the extracted different portion in different portion information of the storage area; and
refer, when receiving a search request which includes a search criterion, to at least one of the common portion information and the different portion information to search for a log message that meets the search criterion.

2. The log management computer according to claim 1, wherein the common portion information and the different portion information include identification information for associating a common portion and a different portion that are extracted from the same log message with each other.

3. The log management computer according to claim 2, wherein the processor is further configured to:
select, when receiving the search request, a common portion that meets the search criterion from common portions stored in the common portion information;
select the different portion that is associated with the selected common portion from different portions stored in the different portion information;
restore the different portion and the common portion to a log message by combining the selected different portion and the selected common portion; and
output the restored log message as a log message that meets the search criterion.

4. The log management computer according to claim 3, wherein the processor is further configured to:
extract a word that constitutes a common portion stored in the common portion information, and store, in the storage area, the extracted word and index information which includes information associating the extracted word with a common portion from which the word is extracted; and
refer, when receiving a search request which includes a keyword as the search criterion, to the index information to select a common portion that meets the search criterion.

5. The log management computer according to claim 2, wherein the processor is further configured to:
select, when receiving the search request, a different portion that meets the search criterion from different portions stored in the different portion information;
select the common portion that is associated with the selected different portion from common portions stored in the common portion information;
restore the different portion and the common portion to a log message by combining the selected different portion and the selected common portion; and
output the restored log message as a log message that meets the search criterion.

6. The log management computer according to claim 1,
wherein the storage area stores different portion definition information in which different portions to be extracted are defined in advance, and
wherein the processor is further configured to:
extract, from one of the log messages, a portion that matches the different portion definition information as the different portion;
extract other portions of the one of the log messages than the extracted different portion as the common portion; and
store, when the extracted common portion is not stored in the common portion information, the extracted common portion in the common portion information.

7. The log management computer according to claim 1, wherein the processor is further configured to:
extract, when one of the log messages includes all portions of one of common portions stored in the common portion information, as the different portion, a portion of the one of the log messages that does not match the one of common portions stored in the common portion information, and extract, as the common portion, other portions of the one of the log messages than the portion extracted as the different portion; and
store, when one of the log messages does not include all portions of one of common portions stored in the common portion information, the one of the log messages in temporary common portion information of the storage area.

8. The log management computer according to claim 7, wherein the processor is further configured to:
extract, from a log message stored in the temporary common portion information, a common portion that is common to the log message and other log messages stored in the temporary common portion information, and extract a different portion which differs from other log messages stored in the temporary common portion information; and
store the extracted common portion in the common portion information of the storage area, and store the extracted different portion in the different portion information of the storage area.

9. A log management computer for managing a log that is obtained from a log generating system for generating a log which is an operation record,
the log including a structured portion and an unstructured portion which includes a log message indicating specifics of operation,
the log management computer comprising:
a storage area for storing the obtained log; and
a processor which refers to the log stored in the storage area, and
wherein the processor is configured to:
extract the structured portion and the unstructured portion from the log obtained from the log generating system, and stores the extracted structured portion in structured portion information of the storage area;
extract, from the extracted unstructured portion, a common portion which is common to the extracted unstructured portion and unstructured portions included in other logs, and a different portion which differs from the unstructured portions included in the other logs;
store the extracted common portion in common portion information of the storage area;
store the extracted different portion in different portion information of the storage area; and
refer, when receiving a search request which includes a search criterion, to at least one of the common portion information and the different portion information to search for a log that meets the search criterion.

10. The log management computer according to claim 9,
wherein the structured portion information, the common portion information, and the different portion information include identification information for associating a structured portion, a common portion, and a different portion that are extracted from the same log with one another, and
wherein the processor is further configured to:
extract a word that constitutes a common portion stored in the common portion information, and store, in the storage area, the extracted word and index information which includes information associating the extracted word with a common portion from which the word is extracted;
refer, when receiving a search request which includes a keyword as the search criterion, to the index information to select a common portion that meets the search criterion;
select the different portion that is associated with the selected common portion from different portions stored in the different portion information;
select the structured portion that is associated with the selected common portion from structured portions stored in the structured portion information;
restore the structured portion, the common portion, and the different portion to a log by combining the selected common portion, the selected different portion, and the selected structured portion; and
output the restored log as a log that meets the search criterion.

11. The log management computer according to claim 9,
wherein the structured portion information, the common portion information, and the different portion information include identification information for associating a structured portion, a common portion, and a different portion that are extracted from the same log with one another, and
wherein the processor is further configured to:
select, when receiving a search request which includes a keyword as the search criterion, a different portion that meets the search criterion from different portions stored in the different portion information;
select the common portion that is associated with the selected different portion from common portions stored in the common portion information;
select the structured portion that is associated with the selected different portion from structured portions stored in the structured portion information;
restore the structured portion, the common portion, and the different portion to a log by combining the selected common portion, the selected different portion, and the selected structured portion; and
output the restored log as a log that meets the search criterion.

12. The log management computer according to claim 11, wherein the processor is further configured to:
identify, when the different portion is extracted from the unstructured portion, the type of the extracted different portion;
store the extracted different portion in different portion information that corresponds to the identified type;
identify, when receiving a search request which includes a keyword as the search criterion, the type of the keyword included in the search request; and
select a different portion that matches the keyword from different portion information that corresponds to the identified keyword type.

13. The log management computer according to claim 9, wherein the processor is further configured to:
extract, when the extracted unstructured portion includes all portions of one of common portions stored in the common portion information, as the different portion, a portion of the extracted unstructured portion that does not match the one of common portions stored in the common portion information, and extract, as the common portion, other portions of the extracted unstructured portion than the portion extracted as the different portion;
store, when the extracted unstructured portion does not include all portions of one of common portions stored in the common portion information, the extracted unstructured portion in temporary common portion information of the storage area;
extract, from an unstructured portion stored in the temporary common portion information, a common portion that is common to the unstructured portion and other unstructured portions stored in the temporary common portion information, and extract a different portion which differs from other unstructured portions stored in the temporary common portion information; and
store the extracted common portion in the common portion information, and store the extracted different portion in the different portion information.

14. The log management computer according to claim 13, wherein the processor is further configured to:
output unstructured portions stored in the temporary common portion information; and
extract, when receiving, from an administrator, an input specifying a different portion of at least one unstructured portion out of the output unstructured portions, the specified portion as the different portion from the unstructured portion for which the input of the different portion has been received, and extract other portions of the unstructured portion than the specified portion as the common portion.

15. A log management method for managing a log in a log management computer, the log being obtained by the log management computer, the log management computer including a processor and a storage area, and being configured to obtain the log from a log generating system for generating a log which is an operation record,
the log management method comprising:
extracting, from a log message which is included in the log stored in the storage area, a common portion which is common to the log message and other log messages and a different portion which differs from other log messages;
storing the extracted common portion in common portion information of the storage area;
storing the extracted different portion in different portion information of the storage area; and
referring, when receiving a search request which includes a search criterion, to at least one of the common portion information and the different portion information to search for a log message that meets the search criterion.
